(19) United States
(12) Patent Application Publication
(10) Pub. No.: US 2021/0118054 A1
(43) Pub. Date: Apr. 22, 2021

(54) RESOURCE EXCHANGE SYSTEM

(71) Applicant: Trovata, Inc., San Diego, CA (US)

(72) Inventors: Brett Turner, San Diego, CA (US); Joseph Drambarean, Encinitas, CA (US)

(73) Assignee: Trovata, Inc., San Diego, CA (US)

(21) Appl. No.: 17/133,289

(22) Filed: Dec. 23, 2020

Related U.S. Application Data
(63) Continuation-in-part of application No. 17/072,940, filed on Oct. 16, 2020.
Application No. 17/072,940 is a continuation-in-part of application No. 15/828,254, filed on Nov. 30, 2017.
(60) Provisional application No. 62/956,063, filed on Dec. 31, 2019.
(60) Provisional application No. 62/956,063, filed on Dec. 31, 2019.
(60) Provisional application No. 62/923,349, filed on Oct. 18, 2019.
(60) Provisional application No. 62/429,002, filed on Dec. 1, 2016.

(51) Int. Cl. G06Q 40/04; G06Q 10/04; G06Q 10/10; G06Q 50/18; G06Q 40/02; G06Q 20/38; G06Q 10/06; G06F 16/22

(52) U.S. Cl. CPC G06Q 40/04; G06Q 10/04; G06Q 10/10; G06F 16/2246; G06Q 40/025; G06Q 20/389; G06Q 10/0631; G06Q 50/18

(57) ABSTRACT

A method of operating a resource credit exchange for a resource of a particular type operates a resource forecaster on the resource model input to generate a resource position and a resource flow and applies the resource position and the resource flow to the resource credit exchange, which is coupled to a plurality of resource provider institutions. The resource credit exchange is operated to generate a digital contract based on the resource position and resource flow and initiate an outflow of resource deposits from a subset of the resource provider institutions to the member company under terms of the digital contract.

### CROSS REFERENCE TO RELATED APPLICATIONS

This application claims priority and benefit under 35 USC 119(e) to US application Serial No. U.S. 62/956,063, filed on Dec. 31, 2019, the contents of which are incorporated herein by reference in their entirety. This application claims priority and benefit under 35 USC 119(e) to US application Serial No. U.S. 62/955,242, filed on Dec. 30, 2019, the contents of which are incorporated herein by reference in their entirety.

This application claims priority and benefit as a continuation in part of application Ser. No. 17/072,940, filed on Oct. 16, 2020, the contents of which are incorporated herein by reference in their entirety. application Ser. No. 17/072,940 claims priority and benefit under 35 USC 119(e) to US application Serial No. U.S. 62/923,349, filed on Oct. 18, 2019, the contents of which are incorporated herein by reference in their entirety.

This application claims priority and benefit as a continuation in part of U.S. patent application Ser. No. 15/828,254, entitled “Financial operating platform for autonomous and semi-autonomous cash forecasting and projecting financial results”, filed Nov. 30, 2017, the contents of which are incorporated herein by reference in their entirety. application Ser. No. 15/828,254 claims priority and benefit under 35 USC 119(e) to U.S. application No. 62/429,002, filed on Dec. 1, 2016, the contents of which are incorporated herein by reference in their entirety.

### BACKGROUND

An important function of operational management for any company is to manage the company's various resources. This involves managing both of resource inflows and resource outflows. It is common for a company's resource inflows to be different from its resource outflows over any given period, due to a variety of factors. The operational management function seeks to maintain adequate resources on hand to meet any operational requirements and/or obligations. It is also good practice to put to efficient purpose any excess resources beyond what is needed to meet a company's short-term obligations and to monetize said excess resources when possible.

Once determinations of resource requirements are made, operation management may work with third party institutions to borrow or lease resources needed to meet the company's short-term obligations; or work through said third party institutions to apply excess resources to generate income. The process of working with such third parties can be slow and cumbersome given internal systems and processes for qualifying and underwriting.

Functions performed in enterprise resource tracking, planning, and allocation have many interdependencies. However they often operate separately from one another as the skills required to perform the duties of each function are different. As a result, the systems used by each function, and the many work flows to produce desired results for each, may be disparate, poorly integrated, and may utilize inefficient manual processes. For example, most companies today still rely heavily on spreadsheets for many core or critical resource management tasks.

Conventional platforms or processes for enterprise resource allocation and planning generate a forecast, which is what a company estimates as its resource availability in the future. The forecast may be derived from various sources and compiled by staff. Once the data is gathered, it may be manually input or imported into spreadsheets (i.e., Microsoft Excel® or Google Sheets®, or the like), often within a forecasting model that is manually created, configured and maintained. A considerable amount of effort and analysis is often required and expended in computing the forecast using a spreadsheet. Once the forecast is determined, it may then be output to certain reports and communicated to managers for review and decision making. A resource flow statement may provide metrics on the inflow and outflow of resources for the company corresponding to completed transactions and may indicate the expected liquidity of the resource at a future point in time.

There is, therefore, an ongoing need for systems that enable the determination of an organization's resource position responsive to recent events and transactions, and to utilize this resource position to generate resource forecasts over configurable time intervals and scenarios.

### BRIEF DESCRIPTION OF THE DRAWINGS

To easily identify the discussion of any particular element or act, the most significant digit or digits in a reference number refer to the figure number in which that element is first introduced.

FIG. 1A depicts a resource co-operative system 100 in accordance with one embodiment.

FIG. 1B depicts the resource co-operative system 100 in additional aspects.

FIG. 2 depicts a resource credit exchange system 200 in accordance with one embodiment.

FIG. 3 depicts a resource management system 300 in accordance with one embodiment.

FIG. 4 depicts a resource credit exchange system 400 in accordance with one embodiment.

FIG. 5 depicts a credit profile 500 in accordance with one embodiment.

FIG. 6A depicts a resource pooling co-operative system 600 in accordance with one embodiment.

FIG. 6B depicts the resource pooling co-operative system 600 in additional aspects.

FIG. 6C depicts the resource pooling co-operative system 600 in additional aspects.

FIG. 7 depicts a user interface 700 in accordance with one embodiment.

FIG. 8 depicts a user interface 800 in accordance with one embodiment.

FIG. 9 depicts a process 900 in accordance with one embodiment.

FIG. 10A depicts a distributed resource management computing platform 1000 in accordance with one embodiment.

FIG. 10B depicts the distributed resource management computing platform 1000 in additional aspects.

FIG. 10C depicts a user application program interface 1052 for the tagging logic 1040 of the distributed resource management computing platform 1000 in accordance with one embodiment.

FIG. 11 depicts a tag-based control structure 1100 to utilize in conjunction with the indexing module 1030 in accordance with one embodiment.

FIG. 12 depicts an embodiment of the indexing module 1030 in additional aspects.

FIG. 13 depicts a computer system routine 1300 in accordance with one embodiment.

FIG. 14 depicts inter-system connection scheduler logic 1400 in accordance with one embodiment.

FIG. 15 depicts connection cadence setting logic 1500 in accordance with one embodiment.

FIG. 16 depicts hot connection logic 1600 in accordance with one embodiment.

FIG. 17 depicts a resource forecast module 1700 in accordance with one embodiment.

FIG. 18 depicts the resource forecast module 1700 in additional aspects.

FIG. 19 depicts a resource forecasting system 1900 in accordance with one embodiment.

FIG. 20 depicts a resource forecasting system 2000 in accordance with one embodiment.

FIG. 21 depicts a method 2100 in accordance with one embodiment.

FIG. 22 depicts a resource forecast 2200 in accordance with one embodiment.

FIG. 23 depicts a resource flow stream 2300 in accordance with one embodiment.

FIG. 24 depicts a factor 2400 in accordance with one embodiment.

FIG. 25 depicts a process 2500 in accordance with one embodiment.

FIG. 26 depicts a client server network configuration 2600 in accordance with one embodiment.

FIG. 27 depicts a machine 2700 in the form of a computer system within which a set of instructions may be executed for causing the machine to perform any one or more of the methodologies discussed herein, according to an example embodiment.

### DETAILED DESCRIPTION

Throughout this disclosure, certain terms are used (e.g., “loan”, “credit”, “liquidity” etc. that are encountered in the field of financial services. It should be understood that use of these terms does not imply or limit application of the systems and techniques to finance applications. In particular the systems and techniques are generally applicable to and intended for management of many types of company/enterprise operational resources, both physical and digital. It should also be understood that such resources and levels/positions thereof may be represented and managed in machine systems digitally, in some cases.

Disclosed herein are embodiments of an environment that includes a resource management system, a collector, a profiler, and a resource credit exchange. The resource management system may be configured to determine a resource position for a company. The collector may be configured to determine credit worthiness based on inputs from one or more enterprise resource planning (ERP) systems for the company. The profiler may be configured to determine a credit profile for the company based on the resource position and the credit worthiness data. The credit exchange may be configured to solicit a loan for the company from a plurality of lenders that subscribe to the credit exchange.

In some configurations the resource management system may include a processor and volatile memory media for storing instructions that, when executed by the processor, cause the processor to perform certain operations. The instructions may cause the processor to receive resource data over a network by way of an application programming interface from a one or more of a resource institution for each resource account of the company, an enterprise resource planning (ERP) system, and user-generated content.

In some configurations, the credit exchange system may include a transaction manager configured to execute a loan transaction between the company and one of the plurality of lenders in response to a lender agreeing to terms for the loan.

In some configurations, the credit exchange system may include a loan manager configured to determine an updated resource position for the company at a point in time subsequent to execution of the loan transaction and configured to modify terms of the loan in response to a change in the credit profile based on the updated resource position.

In some configurations, the credit exchange system may include a loan manager configured to determine updated credit worthiness data for the company at a point in time subsequent to execution of the loan transaction and configured to modify terms of the loan in response to a change in the credit profile based on the updated credit worthiness data.

In some configurations, the credit exchange system may include a loan manager configured to determine an updated resource position and updated credit worthiness data for the company at a point in time subsequent to execution of the loan transaction and configured to modify terms of the loan in response to a change in the credit profile based on the updated resource position and the updated credit worthiness data.

In some configurations, the credit exchange system may include a transaction manager configured to execute a loan transaction between the company and two or more of the plurality of lenders in response to the two or more lenders agreeing to terms for the loan.

In some configurations, the credit exchange may be configured to solicit one or more loans for one or more companies with one or more lenders.

In some configurations, the credit profile may include two or more sequential disclosure levels for data of the credit profile, each sequential disclosure level providing more resource details than a prior sequential disclosure level and the company defines an initial sequential disclosure level used to solicit the loan.

A credit exchange system may include a resource exchange to bring in excess resource from certain companies as invested resources, while sending out resource to certain companies as borrowed resources. The credit exchange system functions outside a resource institution's traditional process of qualifying, approving, and issuing credit to the resource institution's clients so that credit could be issued in or near real time. Thus, the credit exchange system may act as a non-bank intermediary for credit and investment activities of the credit exchange system such as clients, sharing resources similar to a co-op. The system also enables clients who invest their excess resources to receive a rate of return on the invested resources, while clients who borrow resources from the credit exchange may pay an interest or lease rate on any borrowed resources. By using technology and functioning as a non-bank intermediate to identify sources of resource liquidity, clients may be able to reap the benefits of speed and precision in managing and optimizing their operational resources.

In one aspect, the credit exchange system may be operated in connection with a resource management system by a single Software-as-a-Service (“SaaS”) provider automating the process of transferring resources between the credit exchange system and its subscribers/clients.

In another aspect, the credit exchange system may be operated by a SaaS provider in partnership with a resource institution as a credit underwriter to the resource exchange, as resource manager or advisor for invested resources, as a resource bank to store any of the resources within the resource pooling system, or other capacity as part of the SaaS provider's resource management operations or platform or technology.

In one aspect, the credit exchange system may (i) be hosted in the cloud by a cloud provider such as Amazon Web Services, Microsoft Azure, or other cloud or infrastructure-as-a-service provider; (ii) use distributed ledger technology, such as blockchain; (iii) use web or mobile user interfaces; or (iv) use third-party systems of a resource institution partner.

In one aspect, the credit exchange system may act on instructions to borrow from, or invest in, the resource exchange, a certain amount as determined either by the end-user customer, the resource management system, the resource pooling system, a partner resource institution, or third-party system.

In one aspect, any instructions that the credit exchange system acts upon may be either from a human or a machine.

In one aspect, the instructions may make use of any targeted balances, thresholds, limits, amounts, indicators, defined by any of the parties as described in the paragraph above, either by a human or machine using machine learning techniques.

In one aspect, the credit exchange system would be functioning outside a resource institutions traditional process of qualifying, approving, and issuing credit to its clients so that credit could be issued in or near real time. Thus, the credit exchange system serves as a non-bank intermediary for credit and investment activities of its clients, sharing resources as if part of a co-op, however, clients who invest its excess resources would receive a rate of return on such invested resources, while clients who borrow resources from the resource exchange would pay an interest rate on any borrowed resources.

In one aspect, the credit exchange system may automate the movement of resources, such as resource transfer processes, using client accounts and a client's current and forecasted resource needs, and use methods described in above. Such autonomous operations may rely on methods described herein to make decisions to move resources back and forth at a high rate of speed and at a high rate of occurrence in order to manage resource levels to optimal levels on hand for the resource pooling system's clients.

In one aspect, the credit exchange system may provide investment income to clients investing excess resource as determined by various means described herein; and receive interest from clients borrowing resources from the resource exchange.

In one aspect, the credit exchange system may provide clients with resource on-demand either investing or borrowing as needed based on the dynamic nature of its finances. In such a way, the credit exchange system provides flexibility similar to the cloud computing model of elasticity from public cloud providers, such as Amazon Web Services or Microsoft Azure, for on-demand and cost effective Information Technology (“IT”) services that are prevalent in meeting dynamic IT needs of businesses.

Embodiments of a resource pooling system are described to pool and manage resources for companies to meet their operational goals. The resource pooling system may maintain in, or near, real time, a balance of resources among accounts. The system may provide resource positioning and resource forecasting. The resource pooling system may continuously balance resources between a company's accounts to achieve a stable allocation for operational purposes. The resource pooling system may include a resource exchange to import needed resources and to export excess resources from third party resource provider institutions. The resource pooling system may function external to the resource provider institution's traditional process of qualifying, approving, and issuing resources or resource credit or debit settings. In one aspect, the resource pooling system may be operated in connection with a resource management system by a software-as-a-service (“SaaS”) provider automating the process of transferring resources or resource credit or debit settings between the resource pooling system and its subscribers/clients.

A resource exchange, formed similar to a cooperative or co-op, may provide the resource pool for the benefit of its members. Resources may flow between the resource exchange and the resource exchange's member companies as a means toward optimizing member's resources on hand, and improving resource allocation and utilization overall, in a more agile manner than provided by conventional systems.

In one aspect, the resource pooling system may be hosted in the cloud by a cloud provider such as Amazon Web Services, Microsoft Azure, or other cloud or infrastructure-as-a-service provider. In another aspect, the resource pooling system may utilize distributed ledger technology, such as blockchain. In another aspect, the resource pooling system may utilize web or mobile user interfaces. In another aspect, the resource pooling system may utilize systems of a resource provider institution partner.

The resource pooling system may provide clients with resources on-demand and may enable the borrowing, leasing, and/or investing of operational assets dynamically determined from current or near-term operational requirements.

Embodiments of a distributed computing platform are disclosed to implement aspects of resource pooling systems and to automate operational tasks across functional areas within an enterprise. The platform implements a scalable online system for data ingest, indexing, and outflow, with performance-enhancing rate matching between stages.

The system may be configured with named hierarchical filters. As new transactions occur, indexing may be applied across a decoupling boundary, and hierarchical filters (called ‘tags’) may be applied post-index for enhanced performance and customization without necessitating the instrumentation of each transaction. Conventional indexing approaches write fields (e.g., tags) into each transaction that matches a condition. Adding fields into each transaction degrades performance as edits or changes to the tag or any aspect of the parameters utilized by the tag compels the system to scan through the entirety of the index and make changes to each record utilizing the tag, and then re-index.

The disclosed system exhibits improved performance by de-coupling indexing from the parametric constraints of tagging and thus may better match indexing performance with a rate of data ingest and/or data outflow. The disclosed technique enabled faster searching and more effective storage of data than previous methods, and thus provide a specific improvement to the operation of distributed computing platforms, and improves their capabilities for rate-matching inflows to indexing. The disclosed systems provide increased flexibility, faster search times, and potentially reduced memory requirements for data storage.

Multilevel hierarchical tags may be configured so that a parent-child relationship is established through the application of iterative refinements. The indexing operates asynchronously from the data ingest across a decoupling boundary. When ingestion and normalization complete a push notification may be applied across the decoupling boundary to trigger operation the indexing module to update the search index based on anchor tags in relational tables of the normalized data set.

The system enables on-demand retrieval by client devices of highly customized information for use in analytics and reporting, based on recently and periodically acquired data sets from disparate computer server systems with improved performance and lower latency than is available with conventional approaches.

In one embodiment data objects are generated for statistical and competitive modeling at higher resolution than some conventional approaches. Tagged inputs may be structured as nodes such that tags inherit features from parents tags. Tags may be utilized in Boolean combination such that instead of merely narrowing search results, combination tags may map to a wider set of data while also ignoring overlapping results.

In some aspects, a distributed data communication and transformation system includes an ingest module operative on a first side of a de-coupling boundary, the ingest module including a web integration service. The system further includes a normalizing module, and an outflow module operative on a second side of the de-coupling boundary, the outflow module including an indexing module configured to transform outputs of the normalizing module into a search index, the indexing module operative asynchronously from the normalizing module and the web integration service across the de-coupling boundary, and an outflow engine dynamically configurable from the second side of the de-coupling boundary to filter outputs of the search index without signaling across the de-coupling boundary.

In other aspects, a distributed data communication and transformation system includes an ingest module operative on a first side of a de-coupling boundary, the indexing module comprising a hot connection module configured with cadence rules for a plurality of disparate computer server systems. The system further includes an outflow module operative on a second side of the de-coupling boundary, the outflow module including an indexing module operative asynchronously from operation of the ingest module across the de-coupling boundary to transform outputs of the hot connection module into a search index; and an outflow engine dynamically configurable from the second side of the de-coupling boundary to apply onto transaction records referenced in the index a hierarchical transaction grouping control structure configurable from a mobile application independently of a search query session, the hierarchical transaction grouping control structure comprising one or more inheritance tag relationships and one or more container tag relationships.

In other aspects, a method of operating a distributed computer system includes operating an ingest module on a first side of a de-coupling boundary to normalize outputs of a hot connection module, processing the normalized outputs with an indexing module operated asynchronously from the ingest module on a second side of the de-coupling boundary to generate a search index, and operating a mobile application to apply onto transaction records referenced in the search index a hierarchical transaction grouping control structure independently of search query sessions on the search index, the hierarchical transaction grouping control structure comprising one or more inheritance tag relationships and one or more container tag relationships.

The ingest module may push the outputs of the normalizing module across the de-coupling boundary. The hot connection module may be responsive to a plurality of metadata control settings for disparate computer server systems, the control settings implementing cadence rules for connection to and data transfer from the disparate computer server systems. The hot connection module may be configured to execute a connection cadence on each of the disparate computer server systems based on the cadence rules. The normalizing module may implement a plurality of data transformation algorithms to apply to output of the web integration service. The ingest module and the outflow module may be serverless.

Embodiments of a resource forecasting system are also disclosed. A problem with traditional resource forecasting is that by the time the forecast is generated, information utilized to generate the forecast is out of date which may result in inaccurate predictions or forecasts. A company's resource position is typically dynamic and constantly changing. The company continues to operate, and transactions occur daily that impact the resource position. Traditional forecasting often takes too long to gather the needed information to produce a reliable and concrete resource forecast. Identifying the relevant transactions to produce a resource forecast, and accurately accounting for and designating each transaction into appropriate categories and classes, may take days or weeks and a team of analysts, accountants, and experts. The disclosed systems may be utilized to generate a resource forecast in a more reliable, accurate, timely, and trustworthy fashion than conventional manual approaches.

In one aspect, a computer-based operating platform is provided to automate operational tasks across functional areas within the an enterprise. The platform may function as a resource data aggregation hub. In one aspect, the operating platform (a) acquires and aggregates proprietary and non-proprietary resource data from external and internal sources, including but not limited to resource provider institutions, business systems or spreadsheets (i.e., Salesforce.com, Workday, Excel, etc.), accounting systems (i.e., Netsuite, SAP, etc.), market data (i.e., foreign exchange rates, interest rates, world news & events, etc.), and user-generated content; (b) securely stores, manages, monitors, the data; (c) compiles, processes, connects, computes, and enriches the data; and (d) autonomously and/or semi-autonomously forecasts and projects resource positions and performance data and metrics.

The platform may interface with and acquire inputs from at least the following sources: (a) resource provider institutions; (b) Enterprise Resource Planning (ERP) and other business systems or applications that the enterprise depends on to operate; (c) external market data, such as foreign exchange rates or interest rates that may be acquired from third-party aggregators; (d) user-generated content, such as forecasting assumptions; and (e) external global market events. The platform may be connected with each of these data sources via one or more computer communication networks, and via any number of interfaces such as application programming interfaces (APIs). These connections may be configured to enable the platform to automatically “pull” in the relevant data from each of the data sources, or have the data sources automatically “push” the relevant data to the platform, or both. The relevant data may be determined and set by a user, or the platform may utilize machine learning algorithms to intelligently learn which data may be relevant for the platform's functionality. In one embodiment the platform aggregates inputs from these sources into a cloud-native platform, i.e., one or more server computers that are accessible by one or more client computers via a computer network, and securely stores, monitors, manages, and protects this data in the cloud on behalf of its customers.

The platform architecture may comprise a data lake that stores the data, in whichever format the source data provides it, or an amalgamation (for example, raw database data may be stored in CSV or JSON format). The storage format may be structured, unstructured or semi-structured data. The data lake may include a database formed in a computer storage or memory subsystem. The data lake maintains an ever-growing historical view of original resource data for any company. This corpus of data enables the platform to be continuously enhanced without necessarily requiring new data to be input.

In various embodiments, components of the system may be implemented as or interface with a web application, a mobile application, and/or a REST API.

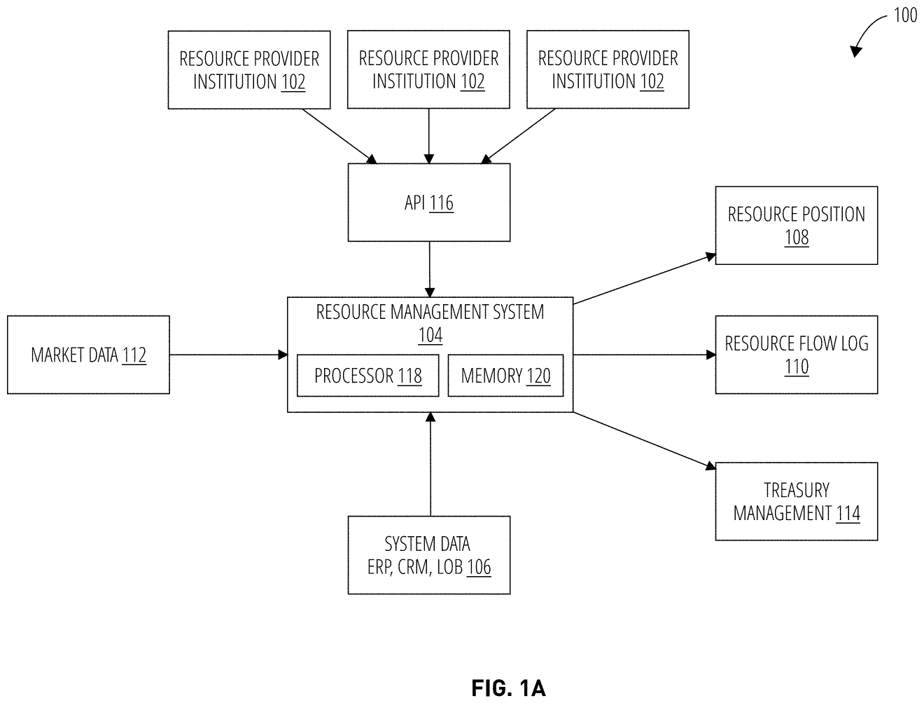

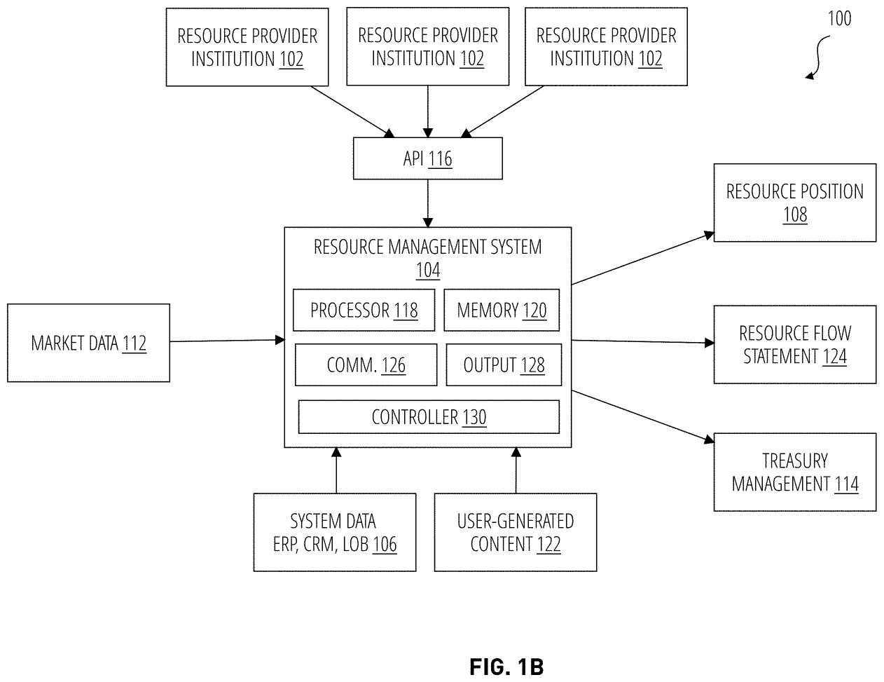

FIG. 1A depicts a resource co-operative system 100 that may be configured to automate and coordinate the allocation of resources for operational tasks across functional areas within an enterprise. The resource co-operative system 100 includes a resource management system 104 with interfaces to resource provider institutions 102, market data 112, and system data 106, such as ERP, CRM, and Line of Business (LOB) data.

Resource provider institutions encompass a broad range of business operations including equipment providers, power providers, bandwidth, storage, communication, and computational resource providers, fuel providers, labor providers, leasing agents, banks, trust companies, insurance companies, brokerage firms, investment dealers, and the like.

The resource management system 104 provides a hub for resource data aggregation, and includes a machine-readable medium storing non-transitory instructions (volatile memory 120) that enables one or more computer processor 118 to execute algorithms to form associations between data elements to compute, analyze, and predict the impact of operations on resource levels. Outputs of the resource management system 104 include resource position 108, resource flow log 110 and treasury management 114. The resource co-operative system 100 may receive resource data over a network by way of an application program interface (API 116) from one or more of the resource provider institutions 102, an enterprise resource planning (ERP) system, and user-generated content.

FIG. 1B depicts additional aspects of the resource co-operative system 100 in one embodiment. A communication module 126 may access resource data over a network by way of the application programming interface (API 116) from one or more of a resource provider institutions 102 for each resource account of the company. The communication module 126 also receives user-generated content and inputs from an enterprise resource planning (ERP) system. The resource co-operative system 100 may include a controller 130 to coordinate the operation of the various components. For example the controller 130 may coordinate the various components to generate a resource position and/or resource forecast to the output module 128. The resource forecast may be provided in reports, and/or applied to other components to perform, for example, resource pool management.

In certain embodiments, a user of the resource co-operative system 100 may provide user-generated content 122 using one or more of the resource position 108, resource flow statement 124, and treasury management 114. In one or more embodiments, a single user or a team of users may generate user-generated content 122 using manual processes, automated processes, other business systems, or a combination of these. In one embodiment, user-generated content may include one or more resource forecasts built based on input, direction, advice, projections, plans, and goals provided by one or more persons. Certain embodiments may provide data and tools to enable the user to generate the user-generated content. For example, a user may reference a resource position, a resource flow statement, and/or treasury management information in generated reports to facilitate the production of resource forecasts.

In one embodiment, the user operates the resource co-operative system 100 to define and generate the user-generated content 122. For example, logic modules of the resource co-operative system 100 may interact with the user to enable the user to define one or more resource forecasts that may serve as user-generated content 122 for the resource co-operative system 100.

In one embodiment, the resource co-operative system 100 enables the user to access real time resource flow data in order to develop the user-generated content 122. Using current resource position 108 information a user may develop a resource forecast as, or as part of, the user-generated content 122. The user may generate the resource forecast based on known business decisions, the user's past experience, known business risks, and one or more outlooks for the company (e.g., optimistic, conservative, and/or pessimistic). In other embodiments the system generates the resource forecast.

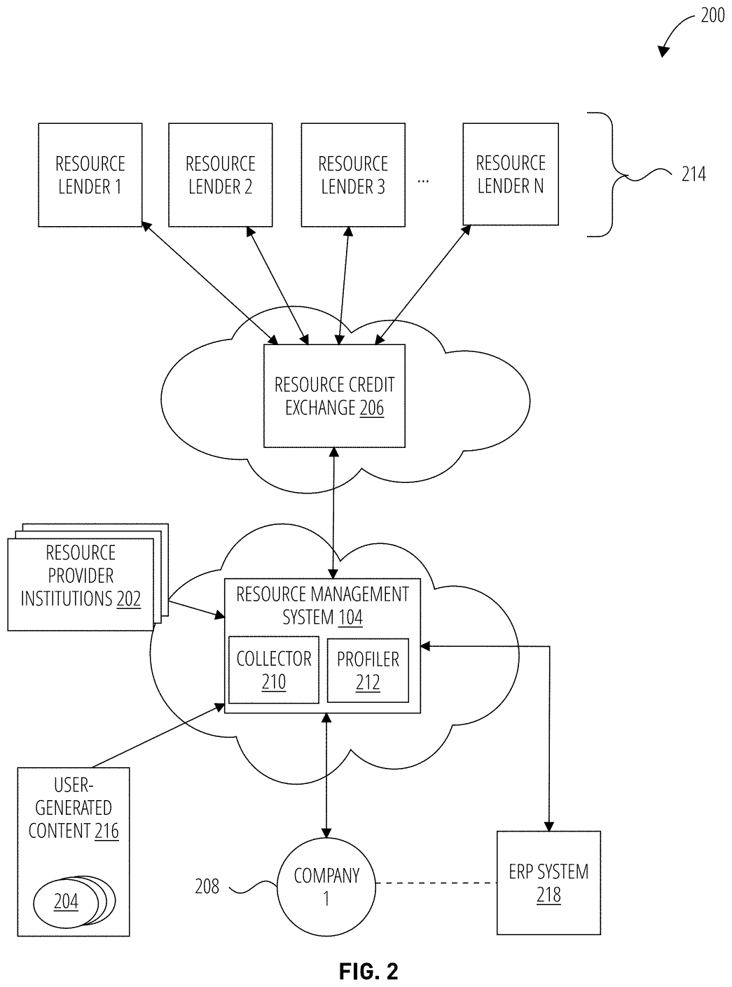

FIG. 2 depicts a resource credit exchange system 200 in accordance with one embodiment. The resource credit exchange system 200 may include a resource management system 300, resource credit exchange 206, a collector 210, and a profiler 212. The resource management system 300 is communicatively coupled to a company 208 and configured to determine a resource position for the company 208. The collector 210 and the profiler 212 provide collection of resource data and generation of a credit profile for the company 208, respectively.

The collector 210 may be configured to determine credit worthiness data based on inputs from one or more ERP systems 218 for the company 208. In certain embodiments, the collector 210 may determine credit worthiness data based solely on inputs from the ERP systems 218. In another embodiment, the collector 210 may determine credit worthiness data based on input from one or more ERP systems 218, from user-generated content 216, such as resource forecasts 204, and/or from resource data available from resource provider institutions 202.

The profiler 212 may determine a credit profile for the company 208, specific to the type of resource, based on the resource position and the credit worthiness data. The resource management system 300 is communicatively coupled to a resource credit exchange 206 that may solicit a loan/lease of the resource to the company from a plurality of resource lenders 214 that subscribe to the resource credit exchange 206. In certain embodiments, the profiler 212 may compute a score for each company that is part of the credit profile. This score provides a metric that lenders can rely on in evaluating the risks in offering loans, and will typically be specific to the type of resource at issue for lend/lease (energy credit, bandwidth, computing resources, equipment, financial resources, etc.).

In some configurations, the resource management system 300 may collect resource data from an ERP system 218 associated with the company 208. In some embodiments, the collector 210 and the profiler 212 of the resource management system 300 may operate as a software service communicating with the resource management system 300 across a network such as in a cloud computing environment. The decentralized configuration may improve response times between and scalability of the operations while allowing for multiple simultaneous operations as the operations may not be limited by the computing resources of a single machine. Further, the resource management system 104 may utilize a scalable architecture with a de-coupling boundary as described in later sections.

With such rich data sources (e.g., ERP systems 218, user-generated content 216, resource forecasts 204, and/or resource position 108) the resource management system 300 may offer a variety of credit profiles for review by resource lenders 214. For example, in one embodiment, the credit profile may be based exclusively on resource position 108 and a resource flow statement 124. In another embodiment, the credit profile may be based on resource position 108, a resource flow statement 124, and ERP system 218 data. In yet another embodiment, the credit profile may be based on resource position 108, a resource flow statement 124, ERP system 218 data, and resource forecasts 204. The one or more resource forecasts 204 used may be of a particular type. For example, a resource lenders 214 may obtain a credit profile based on an aggressive resource forecast 204, or a conservative resource forecast 204. Advantageously, incorporation of the resource forecasts 204 may enable a resource lenders 214 to make lending/leasing decisions based on the projected performance of the company and not on a credit profile limited to only historical data.

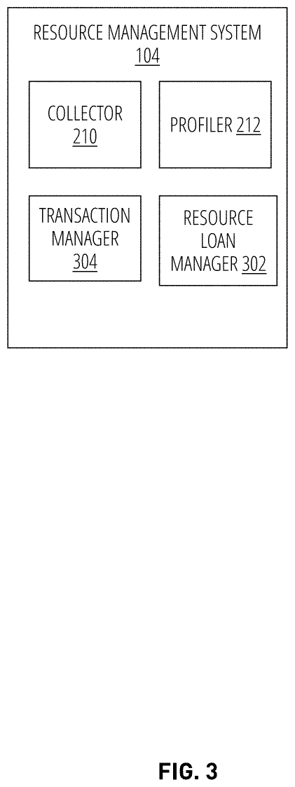

FIG. 3 depicts a resource management system 300 in accordance with one embodiment. The resource management system 300 includes the collector 210, the profiler 212, a transaction manager 304, and a resource loan manager 302. In some configurations, the transaction manager 304 and the resource loan manager 302 may operate within the resource management system 300. In another embodiment, the transaction manager 304 and resource loan manager 302 may operate outside of the resource management system 300.

The transaction manager 304 may manage the initiation of, and the completion of, execution of, a resource loan transaction between a company and a resource provider institution. The transaction manager 304 may accomplish this by executing a resource loan transaction between the company and one of the plurality of lenders in response to a lender and/or company agreeing to terms for the loan. In certain embodiments, the transaction manager 304 modifies, or sets, the terms of the loan in response to rules defined for the resource credit exchange. In one embodiment, the transaction manager 304 executes the loan using a digital contract.

The resource loan manager 302 may monitor the credit of the company in regards to a particular type of resource and modify the loan in accordance with changes in resource data for the company, such as the company's resource position. The resource loan manager 302 may determine an updated resource position for the company at a point in time subsequent to execution of the loan transaction and may modify terms of the loan in response to a change in the credit profile based on the updated resource position.

Various factors may result in an updated resource position, each of these factors may trigger the resource management system and/or a component of the resource management system, such as a loan manager, to determine an updated resource position.

In certain embodiments, the resource loan manager 302 may monitor the credit of the company and change the loan in accordance with changes in the company's resource data, such as their credit worthiness data. This is referred to herein as “real time credit monitoring.” The resource loan manager 302 may determine an updated credit worthiness data for the company at a point in time subsequent to execution of the loan transaction and configured to modify terms of the loan in response to a change in the credit profile based on the updated credit worthiness data.

One advantage obtained from the resource management system 104 is that a lender/leaser of resources and/or company may factor benefits of real time credit monitoring into the terms of the loan. For example, one benefit of real time credit monitoring is that a loan may be extended based on historical financial performance of the company as well as current resource position and/or future resource positions, such as those represented in resource forecasts. Advantageously, using the resource management system 104 a lender (and the company) may obtain a resource position, in real-time or near real time. This is contrasts with conventional gathering of resource position which may take days, weeks, or months.

The resource management system 104 may be utilized to perform real time credit monitoring and report updated credit worthiness data to lenders based on factors that trigger creation of updated credit worthiness data and/or on a periodic basis, or upon request from a lender. The lender may utilize the resource management system 104 to report a company's resource position based on predefined criteria.

A company may revise or update its resource forecasts as circumstances change at the company. Real time credit monitoring enables the lender to weigh any changes in risk with respect to an existing loan, line of credit or request for a new loan.

The time lag time between when a lender requests updated resource position data, resource forecasts, and/or other resource data and receiving that information may thus be reduced. What conventionally may have taken 30-90 days to gather, calculate, certify, and report, may be provided within minutes or hours. The removal of this time delay enables lenders to perform more timely and accurate audits and internal control processes. This in turn enables resource lenders to implement faster and more accurate close-loop controls in response to changes in resource position for companies that have loans/leases from the lender.

In certain embodiments, the resource loan manager 302 may monitor the credit of the company and change the loan in accordance with changes in the company's resource data such as their credit worthiness data and resource position data. The resource loan manager 302 may determine an updated resource position and updated credit worthiness data for the company at a point in time subsequent to execution of the loan transaction and may modify terms of the loan (e.g., in a digital contract implemented on a blockchain) in response to a change in the credit profile based on the updated resource position and the updated credit worthiness data.

In some configurations, the transaction manager 304 may enable the completion of a resource loan transaction between a company and multiple lenders. The transaction manager 304 may execute a loan transaction between the company and two or more of the plurality of lenders in response to the two or more lenders agreeing to terms for the loan and each lender agreeing to extend a portion of the loan and receive a portion of any interest or lease payments. For example, the loan value of the loan transaction to the company may comprise three loans from three lenders that agree to terms amongst the lenders for interest payments and rates. From the perspective of the company, the loan transaction may comprise a single unitary loan.

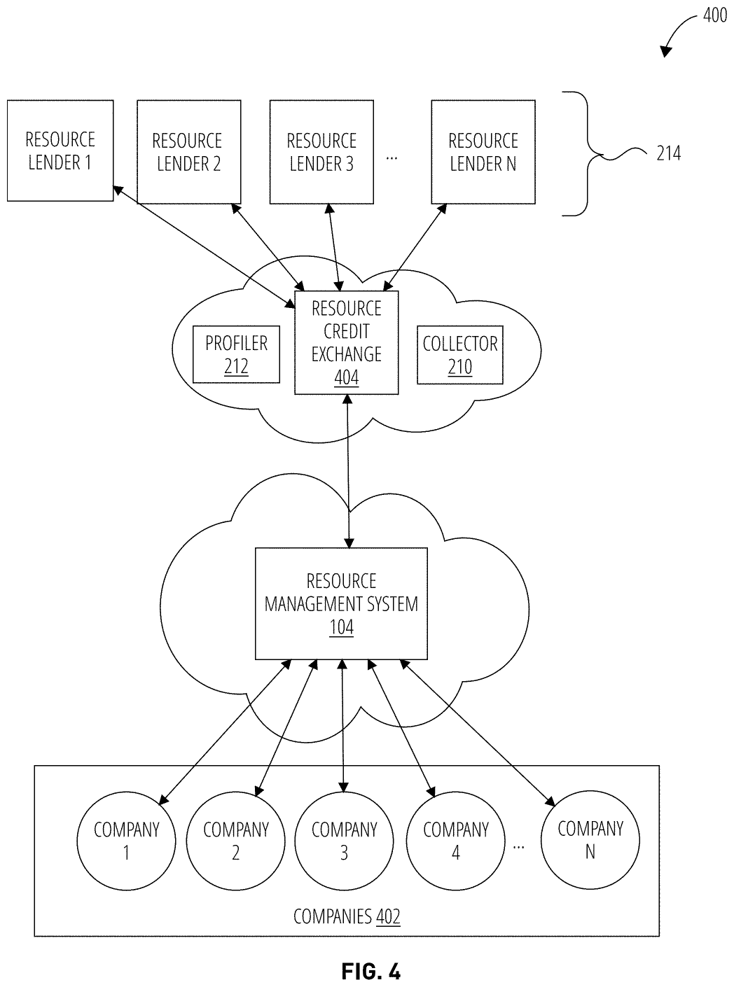

FIG. 4 depicts a resource credit exchange system 400 in accordance with one embodiment. The resource credit exchange system 400 includes the resource management system 104, profiler 212, collector 210, and a resource credit exchange 404. In the resource credit exchange system 400, one or more companies 402 may shop for credit lines from the one or more resource lenders 214 and/or a combination of resource lenders 214 that collaborate to extend a loan. In the resource credit exchange system 400, the resource management system 104 may be communicatively coupled to one or more companies 402 to determine the resource positions for each of the companies 402. The resource management system 104 is also communicatively coupled to the resource credit exchange 404.

In some configurations, the profiler 212 and the collector 210 may operate within the resource credit exchange 404. Alternatively, or in addition, the profiler 212 and the collector 210 may operate over a network and separate from the resource credit exchange 404. The collector 210 and the profiler 212 may receive the resource position information, and/or other resource data, from the resource management system 104. The collector 210 may be configured to gather credit worthiness data from one or more enterprise resource planning (ERP) systems for each of the companies 402. The profiler 212 may determine a credit profile for each of the companies 402 based on the resource position and the credit worthiness data. In such a configuration, the resource credit exchange 404 may be configured to solicit one or more loans for one or more companies 402 with one or more resource lenders 214.

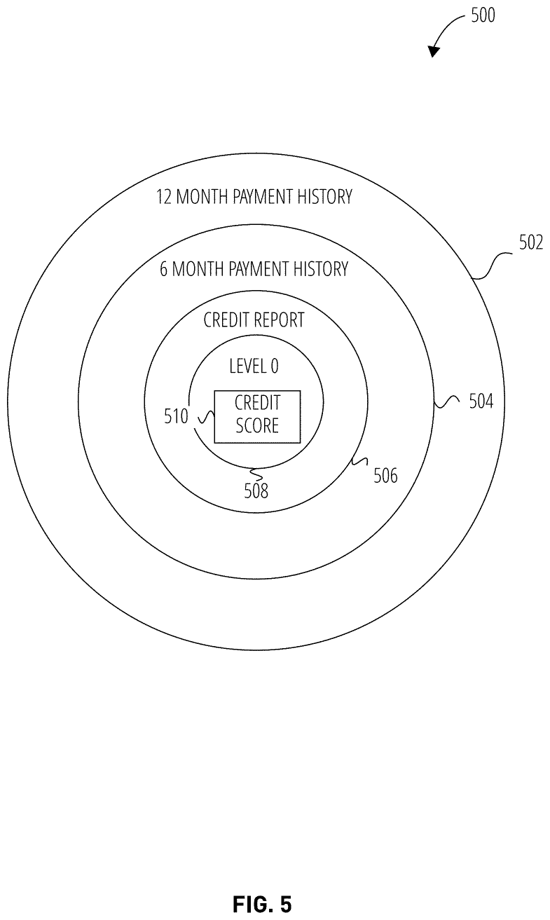

FIG. 5 depicts a credit profile 500 in accordance with one embodiment. The credit profile 500 may be beneficial in situations where a company initially shares a limited amount of their resource data such as a credit score. In the future, the company may be interested in another loan or may seek better loan terms. In one embodiment, to get a loan or better loan terms a company may be willing to share more detailed resource data. In one embodiment, the resource data may be organized into sequential disclosure levels, including an initial sequential disclosure level. In a computer system this may be implemented for example using a hierarchy of access controls for the data, with each access control enabling the release from the resource management system 104 to the profiler 212 of an additional data ring (level) of the credit profile 500 data including any data in the inner rings of the additional ring.

The credit profile 500 may include two or more sequential disclosure levels for data of the credit profile, each sequential disclosure level providing more financial details than a prior sequential disclosure level. Each sequential disclosure level may share more details about the credit profile, and/or credit history of a company.

In the example depicted in FIG. 5, four sequential disclosure levels are indicated. In this example, the initial sequential disclosure level, level 0, may comprise a credit score 510. This initial sequential disclosure level may be used to initially solicit a loan. If the credit score 510 does not solicit an acceptable loan, the company may agree to release more detailed resource data from the credit profile by reconfiguring the access controls on the data. Or, lenders may request more detailed resource data. Consequently, the company may authorize release of one or more subsequent sequential disclosure levels in order to secure a loan and/or secure a loan with favorable terms.

For example, the first level of resource data may be level 0 508 where the basis of the credit profile is a company credit score 510. Level 1 506 of the credit profile 500 may be a credit report which includes resource data used to generate the company credit score 510. Level 2 504 may include a 6-month payment history. Level 3 502 may include a 12-month payment history. In this manner, a company may control how much resource data is shared in the resource credit exchange.

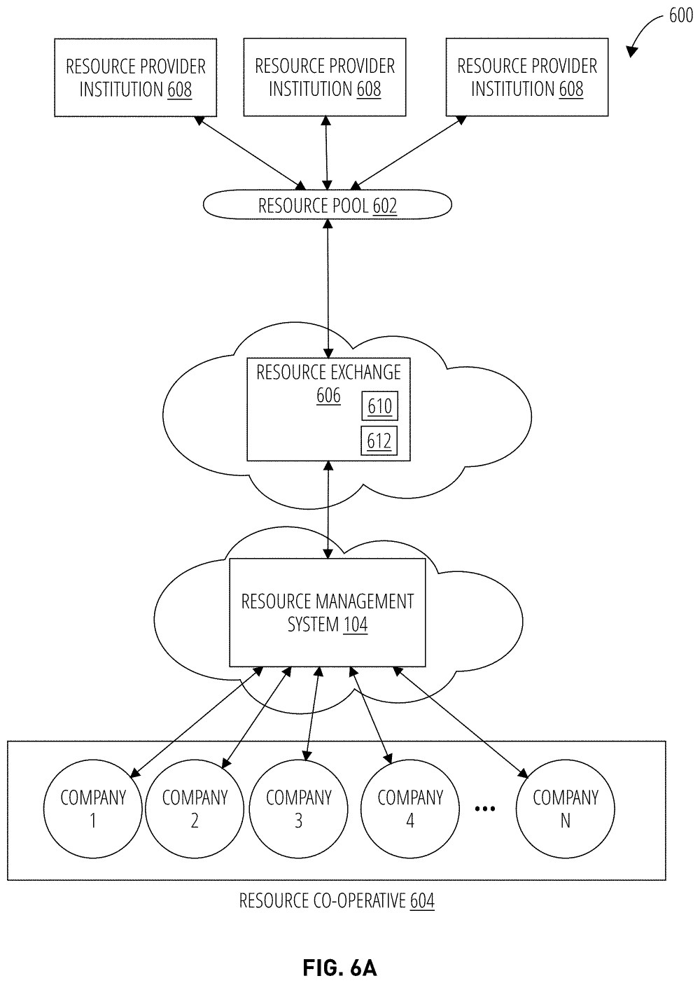

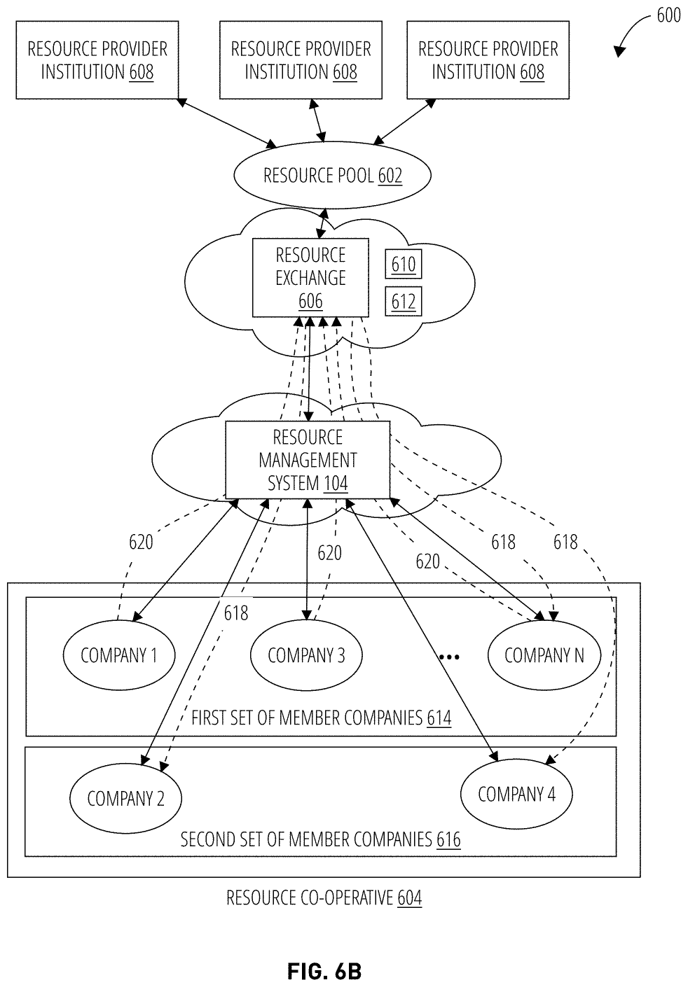

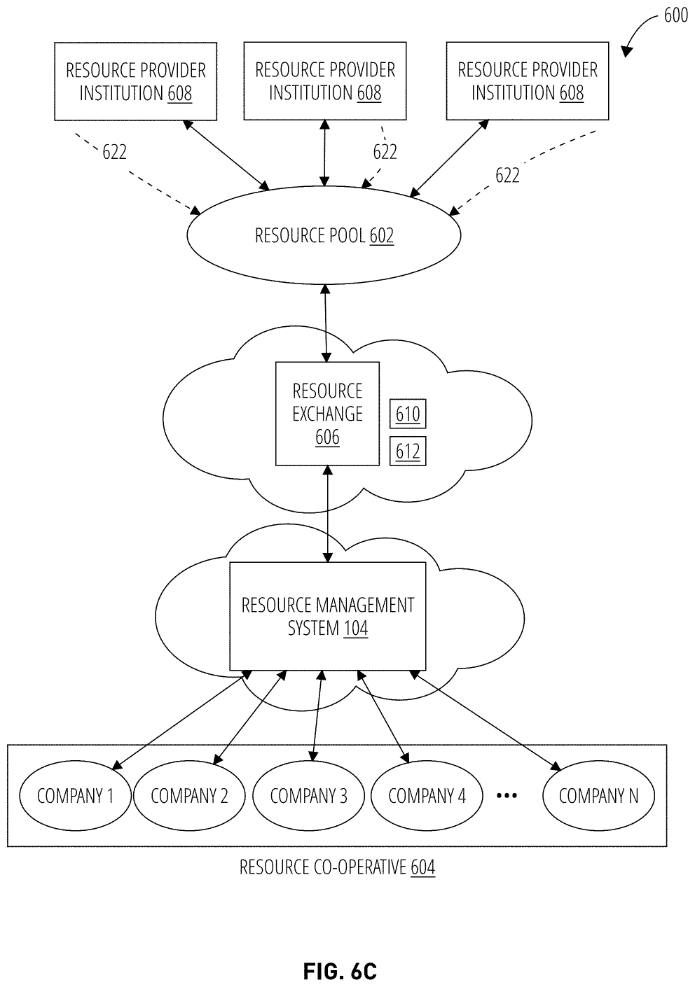

FIG. 6A depicts a resource pooling co-operative system 600 comprising a resource management system 104 enabling a resource co-operative 604 to utilize a resource exchange 606 on a resource pool 602. The resource exchange 606 comprises a resource forecaster 610 and a transaction manager 612.

The resource management system 104 is operatively coupled to a resource co-operative 604. A resource co-operative may comprise a plurality of member companies. The resource management system 104 is also operatively coupled to the resource exchange 606 which is operatively coupled to a resource pool 602. The resource pool 602 in turn is operatively coupled with resource provider institutions 608.

The resource management system 104 may be configured to determine a resource position for a member company within the resource co-operative 604. The resource forecaster 610 may be configured to determine one of a resource deficit needed for the member company for a future time period based on the resource position and excess resources above a threshold level of resources needed for the member company for the future time period. In one embodiment, the resource forecaster 610 may determine a resource deficit or excess resources by way of a resource forecast. The transaction manager 612 may be configured to generate a resource pool loan request in response to the resource forecaster 610 determining a resource deficit and to generate a resource deposit in response to the resource forecaster 610 determining excess resources. The resource exchange 606 may be configured to receive the resource deposits and extend a resource pool loan to the member company.

FIG. 6B depicts additional aspects of the resource pooling co-operative system 600 in one embodiment. The resource management system 104 is communicatively coupled to a first set of member companies 614 and a second set of member companies 616 of the resource co-operative 604.

The resource pooling co-operative system 600 may be operated to receive resource deposits 620 from a first set of member companies 614 into the resource pool 602, the resource deposits 620 comprising excess resources (or settings representing ownership or control of said resources) for operating the first set of member companies 614. If a company in the first set of member companies 614 or the second set of member companies 616 begins to run low on resources, the resource pooling co-operative system 600 may facilitate withdrawing resources from the resource pool 602 and transferring said resources to the company, so that the company has a sufficient amount of resources for anticipated operations. Alternatively, or in addition, the resource pooling co-operative system 600 may then lend resources from the resource pool 602 to a second set of member companies 616 as a resource pool loan 618 in response to each company of the second set of member companies 616 requesting resources in an amount that exceeds a total resource deposit for each particular company.

The resource pooling co-operative system 600 may determine the resource position for a company in the first set of member companies 614 and/or the second set of member companies 616 by way of the resource management system 104 for the company, and may determine risk associated with a resource loan to the company based on the resource position.

In some configurations, a resource lending process of the resource pooling co-operative system 600 may involve determining a credit profile for each company in a set of member companies and approving a resource pool loan 618 in response to the credit profile for each company (or the aggregate) of the set of member companies satisfying a threshold. This configuration may provide scores and/or ranks of member companies that are seeking loans from the resource pool and may utilize the score/rank to adjust the loan terms. This may be utilized to personalize loan agreements in situations in which the members of the resource pool are predetermined to be of the same credit worthiness.

For certain types of resources, the lending process of the resource pooling co-operative system 600 may involve assigning an interest rate or leasing rate for lending to each company of the set of member companies where the interest rate may be based on a credit profile for each company of the set of member companies, and/or on an aggregate credit profile for the set of member companies.

The resource management system 104 may automatically determine a timing and an amount for depositing excess resource deposits 620 of a company into the resource pool 602. The resource management system 104 may initiate the resource deposits 620 in response to one or more triggers. In certain embodiments, a trigger may be detection of an excess of resources on hand during a period of time where the outflow of resources is unlikely. For example, if the company completes several revenue projects that change the resource position of the company to an excess with no immediate expenses, the resource management system 104 may determine that the excess resources may be deposited from the company into the resource pool 602.

The resource management system 104 may also automatically determine a timing and an amount for a resource pool loan 618 from the resource pool 602 to a member company. The resource management system 104 may initiate a resource pool loan request to the resource pool 602 in response to one or more triggers. In certain embodiments, the resource management system 104 may determine, based on the resource flow forecast for a particular company, that the company may need additional resources to meet upcoming operations. In one scenario, the company may be awaiting a large inflow of resources that has taken longer to clear than expected, and thus in need of immediate resources to cover operational needs. In this scenario, the resource management system may determine that the expected inflow of resources would be sufficient to repay the resource pool loan 618 and automatically issue the resource pool loan 618 to the company to cover expected operational requirements.

FIG. 6C depicts the contribution of resources 622 to the resource pool 602 by the resource provider institutions 608. The resource pooling co-operative system 600 may credit each account of a member company of the resource co-operative 604 having a positive balance with a pro rata share of an interest payment or leasing payment from one or more members of the resource co-operative 604.

In some configurations, the resource pooling co-operative system 600 may maintain the resource pool 602 at a predetermined amount by lending resources 622 from the resource provider institutions 608 to the resource pool 602 in response to reaching a predefined resource position level in the resource pool 602.

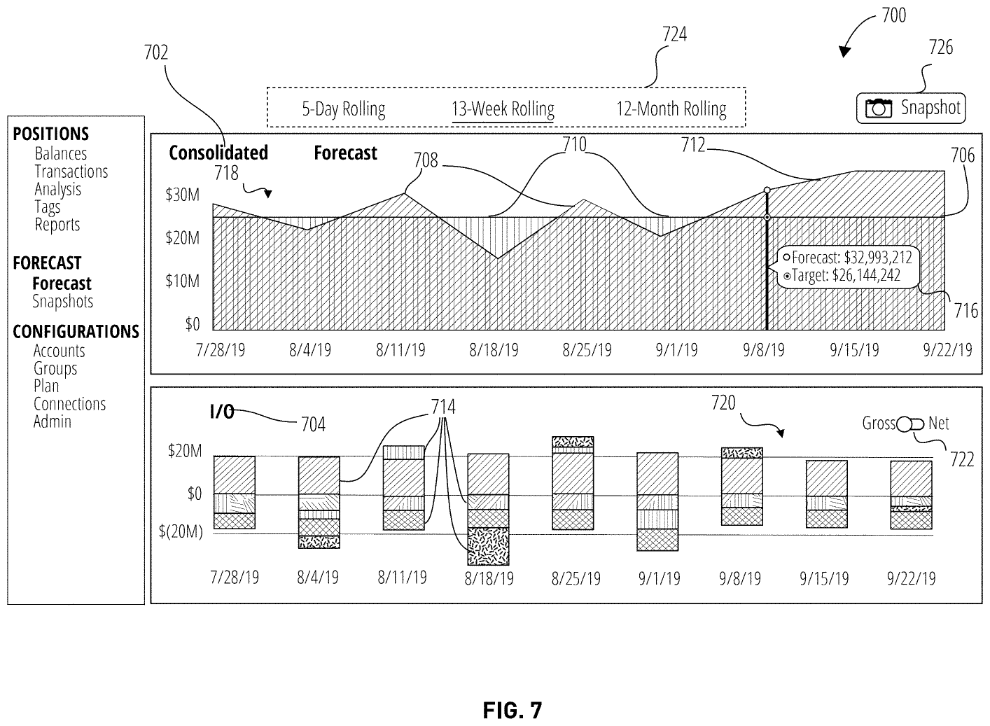

Referencing FIG. 7, a user interface 700 depicts company's projected resource balance 702 and inflows and outflows 704 for various resource categories 714 in a graphical layout. The company's projected resource balance 702 includes a chart 718 depicting optimal level of resource to be maintained 706, shortfalls 710, and when there is resource in excess 708. The optimal level of resource to be maintained 706, indicated by the horizontal line, may be determined from the company's projected resource balance 702 utilizing the resource in excess 708 and shortfalls 710.

In this example, during some weeks, the company may have resource in excess 708 for funding operations—for example paying its suppliers or meeting payroll obligations to its employees. In another scenario, resource in excess 708 may be due to the company collecting more from customers for the products it sells in those weeks than anticipated. During other weeks, the company may have shortfalls 710 and may need more resources than what it has on hand to fund operations.

In a later scenario 712, the company continues to sell more products than forecast, and pays out less to its suppliers, and thus maintaining a consistent level of positive resource flow in excess of its operating levels. These resources are candidates to be loaned/leased out as investments.

The chart 718 comprises an indicator 716 that identifies the forecasted value and the target value of resources for a particular date. The inflows and outflows 704 comprise a graph 720 showing resource categories 314 as bar graphs delimited by a line indicating whether a resource category is in the inflow or outflow for a particular date. The inflows and outflows 704 may be switched between a gross or net view based through the use of a selector 722.

The company's projected resource balance 702 and the inflows and outflows 704 may be viewed in context with a time range selector 724. The time range selector 724 comprises viewing ranges from a five day rolling forecast, a thirteen week rolling forecast, and a twelve month rolling forecast. These forecast selections change the view of the company's projected resource balance 702 and the inflows and outflows 704 display different values for the selected interval. The user interface 700 may also include a snapshot button 726 enabling a user to take save a forecast for the company's projected resource balance 702 and the inflows and outflows 704 for later viewing.

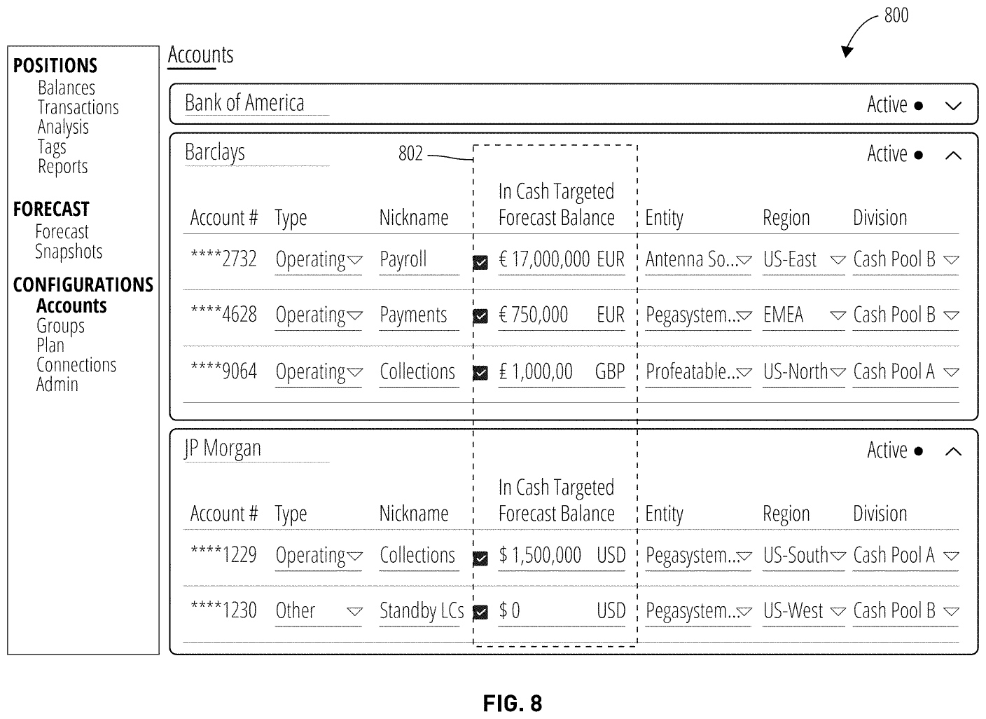

FIG. 8 depicts a user interface 800 comprising a resource pooling system's predefined set points for managing to certain targeted balance objectives on a per-account basis. Although the resource at issue in this example is a purchasing resource, the invention is not in any way limited or specific to financial resources. Other, non-limiting examples of resources that may be managed include computing resources (e.g., storage, processing, bandwidth), fuel, energy, water, gas, or other utility, inventory, labor capacity, and office space.

The user interface 800 depicts each bank account with an amount 802 representing a resource balance. If the actual amount falls below this amount for a configured time period, the resource exchange may draw resources from the resource pool to bring the account balance up to the targeted level amount 802. Conversely, if the account balance rises above this amount during the configured time period, the resource exchange may transfer the excess resources into the resource pool to reduce the account balance to the targeted level amount 802.

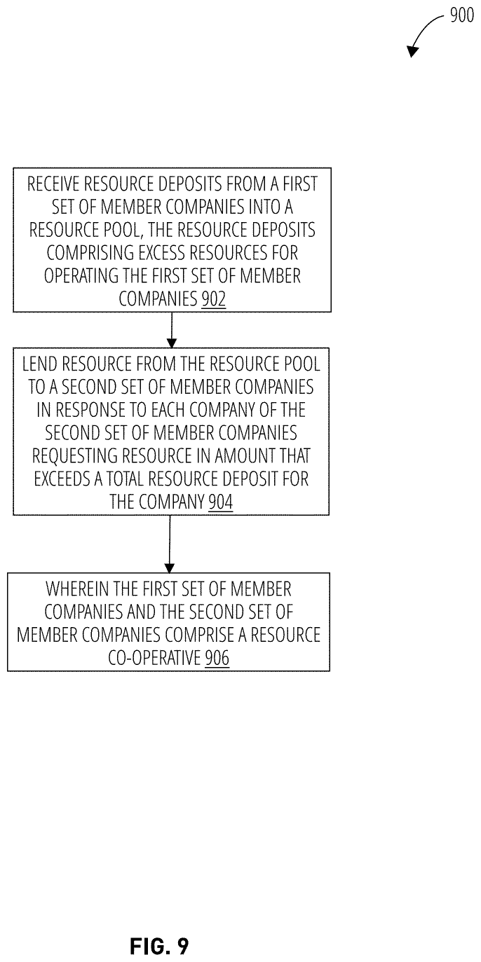

Referencing FIG. 9, a process 900 for operating a system for pooling resources from member companies may involve receiving resource deposits from a first set of member companies into a resource pool, the resource deposits comprising excess resources for operating the first set of member companies (block 902). In block 904, process 900 lends resources from the resource pool to a second set of member companies in response to each company of the second set of member companies requesting resources in an amount that exceeds a total resource deposit for the company. In block 906, this effectively forms the first set of member companies and the second set of member companies into a resource co-operative.

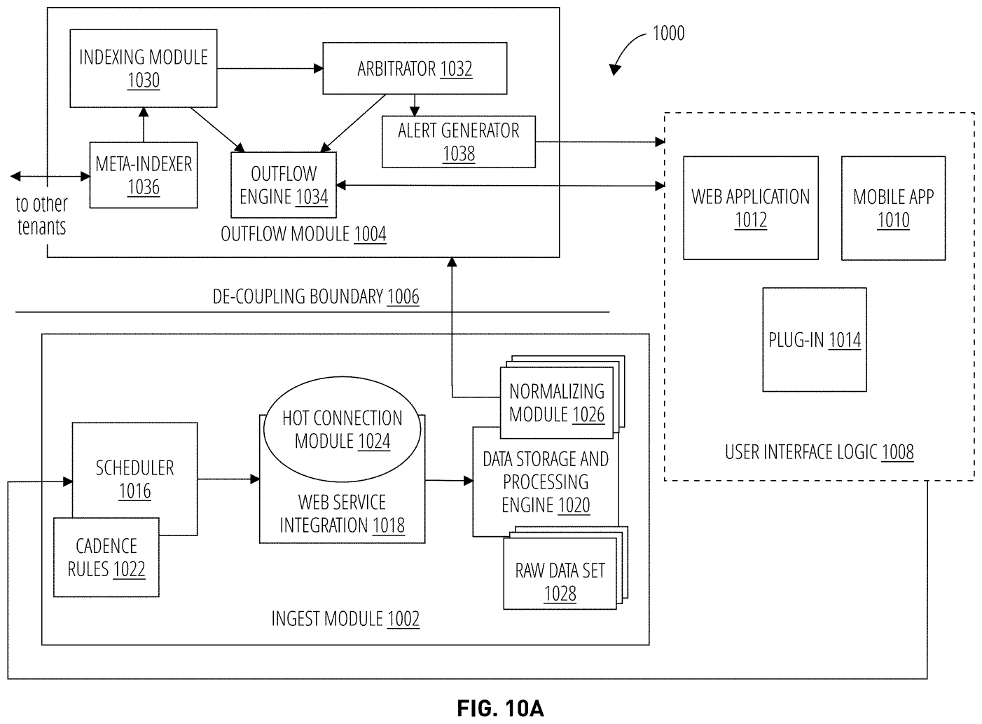

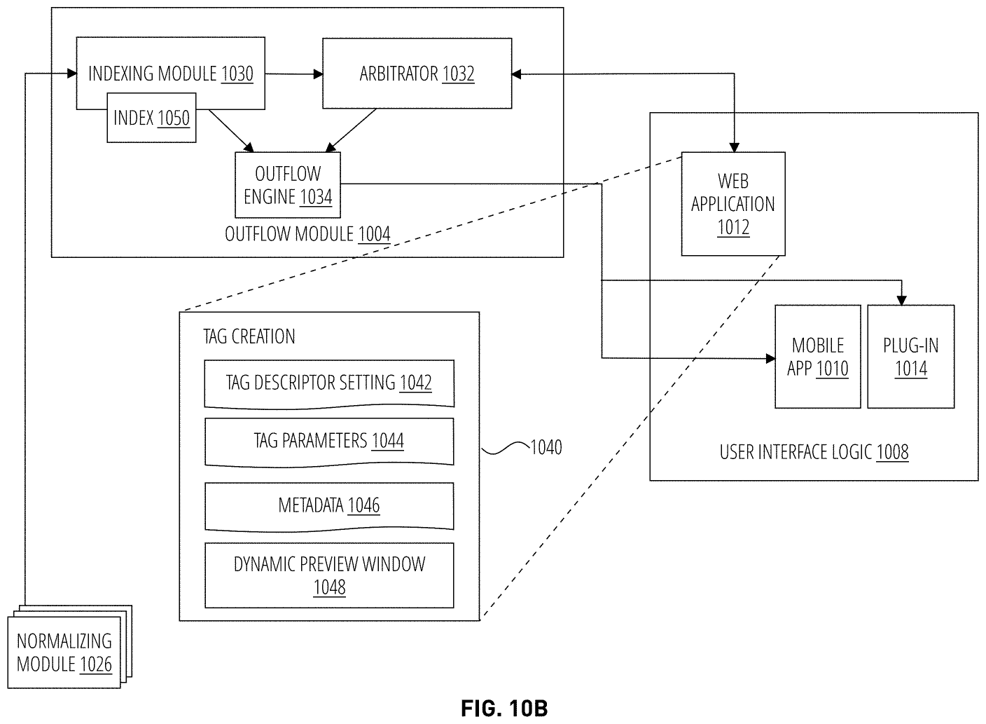

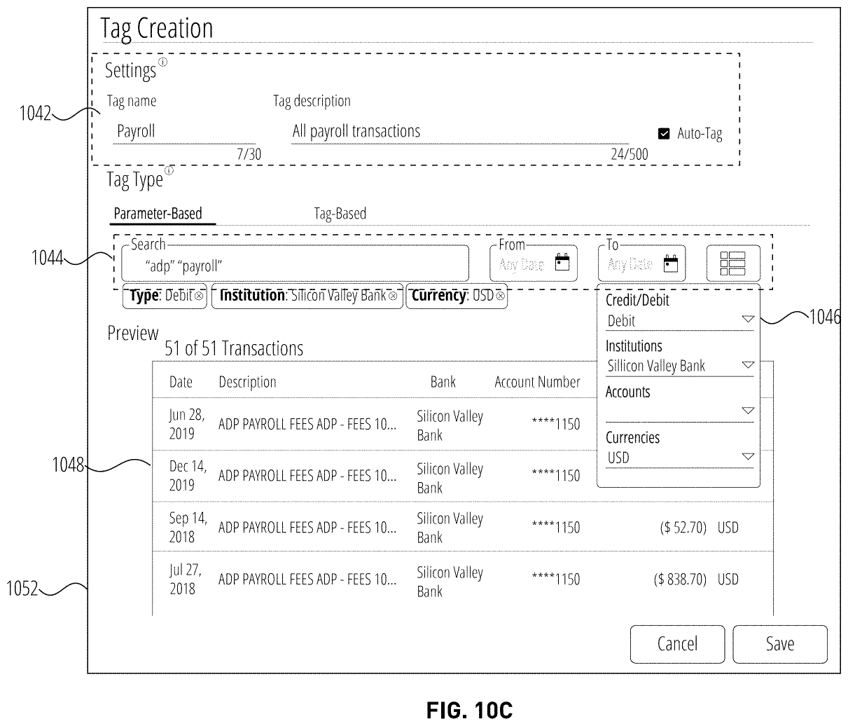

FIG. 10A depicts a distributed resource management computing platform 1000 in one embodiment that may be utilized in a resource pooling system and/or resource forecaster (e.g., as the resource management system 104). At a high level, the distributed resource management computing platform 1000 comprises an ingest module 1002 and an outflow module 1004 that interoperate across a de-coupling boundary 1006. The ingest module 1002 and outflow module 1004 exchange data and control signals with user interface logic 1008.

The ingest module 1002 is operatively coupled to the user interface logic 1008 and activates on a schedule to pull data from disparate computer server systems. The ingest module 1002 is operatively coupled to the outflow module 1004 and passes normalized data across the de-coupling boundary 1006 to the outflow module 1004. The outflow module 1004 is communicatively coupled to the user interface logic 1008 allowing a user to instrument a pipeline of normalized data from the ingest module 1002 to the outflow module 1004 and from there to the user interface logic 1008 using hierarchical filter control settings, referred to herein as ‘tags’.

The user interface logic 1008 depicted here includes one or more of a mobile application 1010, a web application 1012, and a plug-in 1014. The mobile application 1010 and the web application 1012 enable user interaction with and configuration of the distributed resource management computing platform 1000. The plug-in 1014 provides an interface between a restful logic component such as Excel and the distributed resource management computing platform 1000.

The ingest module 1002 comprises a scheduler 1016, a web service integration 1018, and a data storage and processing engine 1020. The ingest module 1002 is a serverless implementation that activates and deactivates services dynamically to ingest raw data from disparate computer server systems into a normalized format, according to individual schedules for each of the disparate computer server systems. Data ingest is controlled by a scheduler 1016 and cadence rules 1022. The scheduler 1016 utilizes the cadence rules 1022 to operate the web service integration 1018, which opens connections and pulls data for further processing by the data storage and processing engine 1020.

A hot connection module 1024 manages the connections utilized by the web service integration 1018 to pull data from the disparate computer server systems. The web service integration 1018 invokes a dynamic application program interface (API) to each of the disparate computer server systems; each API may be specific to a particular server system and the connection via the API is controlled and maintained by the hot connection module 1024.

The data storage and processing engine 1020 operates a normalizing module 1026 on a raw data set 1028 received from the web service integration 1018. This results in a normalized data set with consistent fields regardless of the specific format of the raw data sets from different ones of the disparate computer server systems. The normalizing module 1026 utilizes a dynamically activated set of algorithms specific to the format of the data source. These algorithms perform functions such as file conversion, parsing, and analysis, and are well known in the art.

The connections established and maintained by the hot connection module 1024 are “hot connections” that are opened and closed dynamically such that the connection is made persistent per rules established by institution-specific security protocols—OAuTH, tokenized, dual authentication etc. These rules may be configured in the hot connection module 1024 or the scheduler 1016 or both.

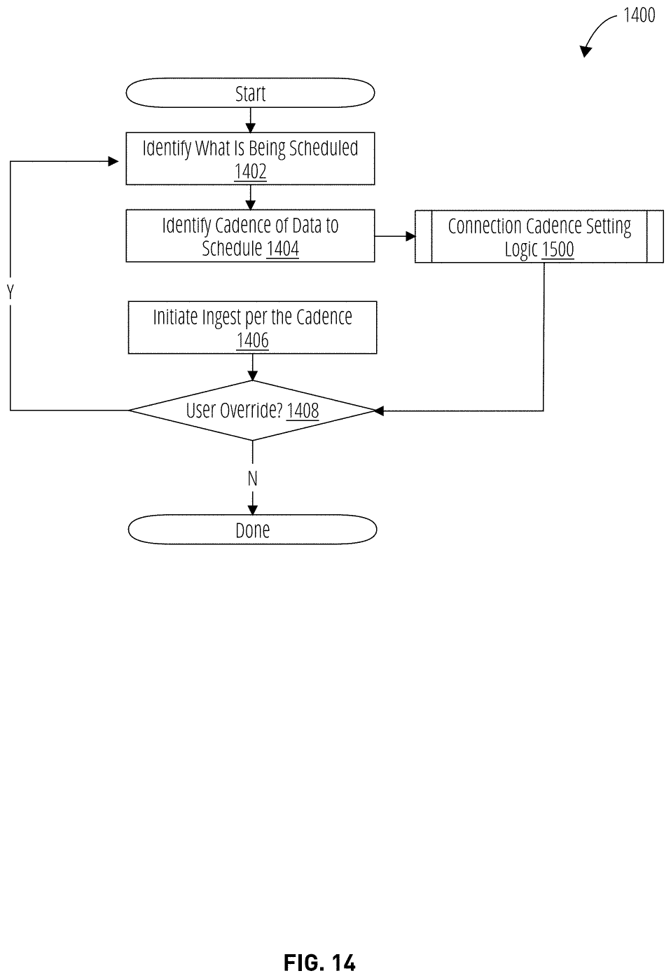

The scheduler 1016 acts as a throttle/rate limiter based on a hierarchical prioritization of at least the following parameters (see FIG. 14):
1. institution restrictions on data access (connections or data amounts) per time interval
2. data availability or update schedules
3. user access privileges for the institution (what data are they allowed access to and how often)
4. institutional limits on data transfer amounts/rates per session

Normalized data is communicated from the ingest module 1002 to the outflow module 1004 across the de-coupling boundary 1006. The de-coupling boundary 1006 is a computer resource utilization boundary separating the operation of the ingest module 1002 and the outflow module 1004. The de-coupling boundary 1006 enables the ingest module 1002 to operate independently and at a different rate from the outflow module 1004; particularly the indexing module 1030 of the outflow module 1004 may operate asynchronously from the ingest and normalization of data by the ingest module 1002.

The outflow module 1004 comprises an arbitrator 1032, an indexing module 1030, and an outflow engine 1034. The outflow module 1004 is a serverless implementation for data delivery for which services are activated and deactivated dynamically per client. The indexing module 1030 is operatively coupled to the arbitrator 1032 which manages contention for the outflow engine 1034 among the various clients requesting data via the user interface logic 1008. The arbitrator 1032 also controls the operation of the outflow engine 1034 based on hierarchical filters configured via the web application 1012, as depicted in FIG. 10B.

The user interface logic 1008 may be operated to configure the indexing module 1030 with multiple tagss to configure a multi-level control structure. During a session that occurs as part of a query or keyword search, the query is input to the outflow module and applied to the indexing module 1030 as a setting. Settings on the app 2602 operate such that when a new batch of data is received across the de-coupling boundary 1006 during the session the new batch of data is binned according to the settings determined by the query. Because this takes place in the context of a query session, it functions as a sticky setting that affects future normalized data that comes across the de-coupling boundary 1006 to the indexing module 1030.

Index settings may be implemented as tags that transform the identified transaction data. The indexing module 1030 receives normalized transaction data from the ingest module 1002 and transforms the normalized data through the application of the tags that label the transaction data associated with the query. This process may be performed asynchronously from the operation of the outflow module 1004.

The tags are utilized to build a query structure for refining and/or enhancing the set of returned transaction data in response to a query. The tags implement a nodal structure for transaction data by combining tagged data into data sets. When tags are combined any duplicate entries are identified to avoid collision (double counting). A combination of tags may be applied to form sets of transaction data meeting complex criteria. The ingest module 1002 is enabled to process new batches of transaction data to remove duplicates transactions that overlap with previous tags.

The user interface logic 1008 may enable the application of exclusion tags that embody settings for the exclusion of data sets from results of multiple queries. For example, there may be parent tag comprising a plurality of tags (e.g., 80 tags) that maps to a large set of transactions. In some instances, the data set matching these parent tags may return undesirable results (e.g., unrelated entries, etc.,) that may originate from a change in a data sources naming schema. Identifying and removing or modifying specific existing tags that give rise to the undesirable results may be complex computational task. Exclusion tags may be added to remove the unwanted entries without removing or modifying existing tags. The exclusion tags may be added in the same manner as other tags.

The meta-indexer 1036 controls the indexing module 1030 based on the activity of multiple tenants of the distributed resource management computing platform 1000. In the distributed resource management computing platform 1000, multiple tenants may share the same executions resources to perform their operations while keeping their data separate. A meta-indexer 1036 may be implemented with access to the data from all the tenants utilizing the distributed resource management computing platform 1000. The meta-indexer 1036 may analyze the larger data set and identify structures within the larger data set that have common attributes. The meta-indexer 1036 may form tags that target these structures and these tags may be presented as suggestions to the the various tenants. In some configurations, the meta-indexer 1036 may globally monitor the activities of the indexing module 1030 from different tenants and identify tags that are applied. These tags may be suggested or automatically applied to data of the various other tenants.

In some configurations, the outflow module 1004 may include an alert generator 1038 for generating alerts to the user interface logic 1008 based on sensitivity settings configured at locations of the indexing module 1030's generated control structure(s). The alert generator 1038 communicates with the arbitrator 1032 which generates an alert notification that is communicated to the user interface logic 1008 when the condition defined by the sensitivity settings are met. The tags may also include sensitivity settings that not only are activated during client runtime sessions, but that may also activate asynchronously outside of runtime sessions. These sensitivity settings generate alert notifications for the mobile application when certain values, events, combinations thereof, or other conditions of the index are detected.

For example, a tag is set up that identifies a large data set. Within this tag a condition or trigger may be configured to generate an alert if an entry or transaction is identified at indexing time as having a value that exceeds a threshold. As the indexing module 1030 is running in real time on data flowing in from the ingest module 1002 and building the control structure, the arbitrator 1032 is reading is reading all the entries that are indexed. Upon detecting the conditions or triggers, the arbitrator 1032 communicates to the alert generator 1038 which sends an alert to the user interface logic 1008. The alert generator 1038 may be also configured to communicate to the alert as a push notification to the mobile application 1010, plug-in 1014, the web application 1012, or combinations thereof.

The distributed resource management computing platform 1000 may, in one embodiment, operate according to the processes depicted in FIG. 14 through FIG. 16.

FIG. 10B depicts tagging logic 1040 in one embodiment. The web application 1012 is depicted in more detail and comprises tagging logic 1040 that provides a tag descriptor setting 1042, tag parameters 1044, metadata 1046, and a dynamic preview window 1048.

The tagging logic 1040 enables the configuration of tags comprising settings. The tag descriptor setting 1042 is a label to concisely reference the tag for future use. The tag parameters 1044 along with the metadata 1046 form settings to apply to structure the normalized data generated by the ingest module. The metadata 1046 may for example identify specific institutions, accounts, currencies, and/or transaction types. Other types of metadata 1046 may also be selectable. The dynamic preview window 1048 displays normalized data that would be associated with the tag as it is currently configured. To form a hierarchical control structure, one or more tag descriptor setting 1042 for existing tags may be set in the tag parameters 1044. The tag parameters 1044 may be generated in many ways, including explicit selections, automatically from search queries, and from natural language inputs. The tag parameters 1044 may be applied as “fuzzy” parameters as that term is normally understood in the art. Some of the tag parameters 1044, such as the institutions and accounts, may be “anchor” settings that associate with specific records in one or more database comprising the normalized transaction records.

The control structures based on tags are configurable from the mobile application 1010 of end users, independently of a search query session between the mobile application 1010 and the outflow module 1004. Tag-based structuring may be applied to the transaction index 1050 independently for each user and/or organization, rather than being a global property of the index 1050.

Substantial performance improvements are realized by building the search index 1050 based on relational tables in the normalized data set that includes fields for the anchor tag parameters 1044, and then generating search results from the index 1050 constrained by groupings defined by a hierarchical control structure comprising tag parameters 1044 that are not anchored but instead implemented as controls applied to the transaction records in the index 1050. The groupings are applied dynamically (as client requests are received). The control structure may for example implement white list and black list constraints on search engine results returned to the web application 1012 by the outflow engine 1034.

The indexing module 1030 is asynchronously coupled to the normalizing module 1026 to receive the normalized data across the de-coupling boundary 1006. The web application 1012 is communicatively coupled to the arbitrator 1032 to configure the arbitrator 1032 with one or more configured tag for the outflow engine 1034 to apply to the index 1050 generated by the indexing module 1030. The outflow engine 1034 is operatively coupled to communicate result sets thus generated to the mobile application 1010 and/or the plug-in 1014 (for example).

The distributed resource management computing platform 1000 may in one embodiment operate according to the process depicted in FIG. 14 through FIG. 16.

FIG. 10C depicts a user application program interface 1052 for tagging logic 1040 in one embodiment. The user application program interface 1052 comprises a tag descriptor setting 1042, a dynamic preview window 1048, a metadata 1046, and a tag parameters 1044. The tag descriptor setting 1042 include the tag name and tag description fields. A user sets a label for the tag (e.g., “Payroll”) and a tag description (e.g, “All payroll transactions”) to help identify the tag later on. A user may also select the auto-tag option to continue automatic tagging of new transactions ingested into the system that match the tagging criteria.

Tags may also be configured by type. There are parameter based tags, and tag-based tags. Parameter based tags are tags created based on a set of tag parameters 1044 such as query values (e.g., terms), date ranges and metadata 1046 such as the transaction types, data source names, accounts, and currencies (e.g., USD, etc.,). Tag-based tags are combination tags to identify existing tags to be utilized in combination with a new tag. A tag-based tag may comprise Boolean or mathematical, or both, combinations of parameter-based tags and/or other tag-based tags.

With each configuration of the tag parameters 1044, transactions within the dynamic preview window 1048 are modified to reflect the change in parameters. When a user is satisfied with the results, they may save the created tag.

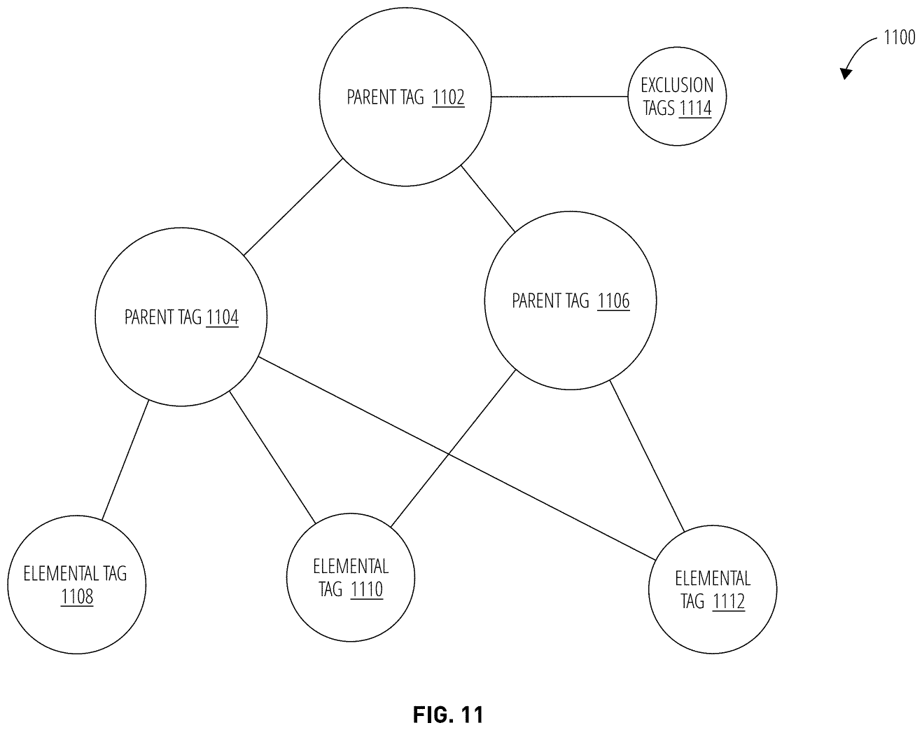

FIG. 11 depicts a control structure 1100 in one embodiment. The control structure 1100 comprises a top-level parent tag 1102 that inherits structure from a parent tag 1104 and parent tag 1106. These in turn inherit structure from elemental tag 1108, elemental tag 1110, and elemental tag 1112. Exclusion tags 1114 are applied in this example to the top-level parent tag 1102.

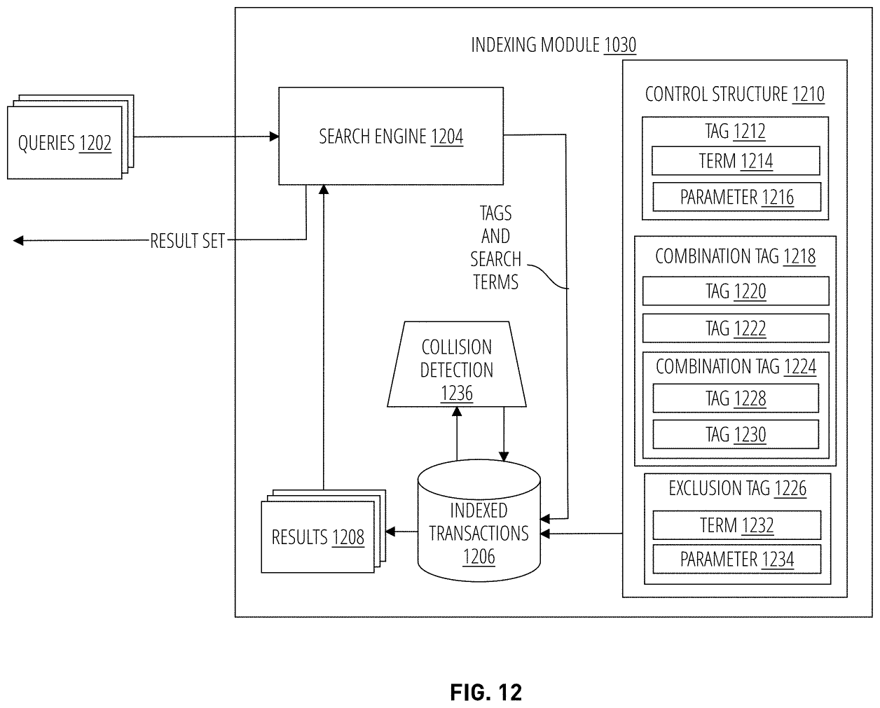

FIG. 12 depicts an indexing module 1030 in one embodiment. Queries 1202 are input to the search engine 1204 and applied against a database of indexed transactions 1206 to generate results 1208 returned to the mobile application 1010. The search engine 1204 applies tags from the queries 1202 and/or search terms from the queries 1202 to the indexed transactions 1206. The control structure 1210 imposes a grouping structure within the indexed transactions 1206 as transactions are received across the de-coupling boundary 1006. This structure is traversed to match the tags and search terms from the queries 1202. The control structure 1210 is organized asynchronously from the queries 1202 (e.g., using the web app) and rate matched to the operation of the ingest module 1002.

When viewed in conjunction with FIG. 11, it may be appreciated that the control structure 1210 may be structured hierarchically both in terms of inheritance (vertical and lateral i.e. parent-child or sibling-sibling inheritance) and container (nesting) relationships among tags.

The control structure 1210 in this example comprises a hierarchical structure of tags. At the highest level are parameter tag 1212 (comprising term 1214 and parameter 1216), combination tag 1218 (comprising parameter tag 1220, parameter tag 1222, and combination tag 1224), and exclusion tag 1226. The combination tag 1224 of the combination tag 1218 comprises parameter tag 1228 and parameter tag 1230. The exclusion tag 1226 comprises term 1232 and parameter 1234. The control structure 1210 demonstrates the richness of possible grouping structures that may be imposed on the indexed transactions 1206. Collision detection 1236 is performed on the groupings to remove duplicates from the grouping structures of the indexed transactions 1206.

The decoupling of transaction indexing from ingest, of transaction indexing from formation of the control structure 1210 imposed on the indexed transactions 1206, and of both indexing and formation of the control structure 1210 from runtime filtering, may substantially improve both performance of the search engine 1204 and the flexibility and richness of the results 1208 generated in response to the queries 1202.

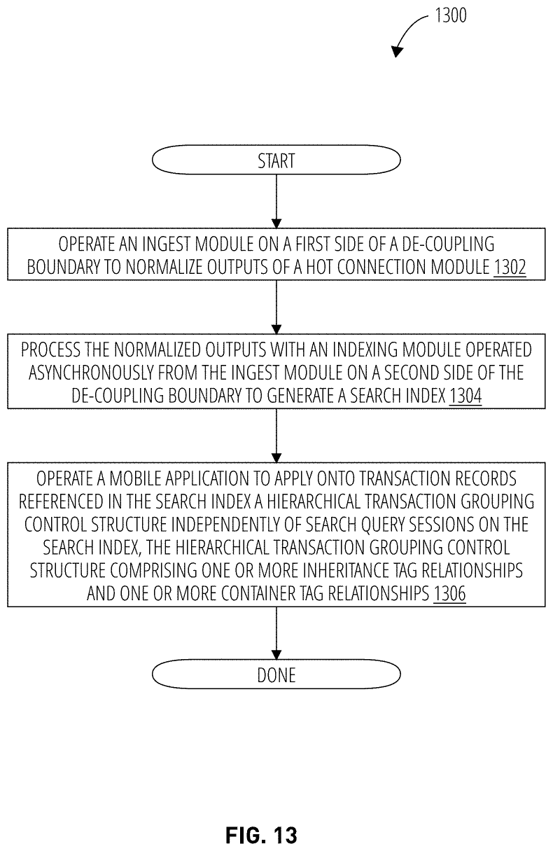

FIG. 13 depicts a computer system routine 1300 in one embodiment. In block 1302, the computer system routine 1300 operates an ingest module on a first side of a de-coupling boundary to normalize outputs of a hot connection module. In block 1304, the computer system routine 1300 processes the normalized outputs with an indexing module operated asynchronously from the ingest module on a second side of the de-coupling boundary to generate a search index. In block 1306, the computer system routine 1300 operates a mobile application to apply onto transaction records referenced in the search index a hierarchical transaction grouping control structure independently of search query sessions on the search index, the hierarchical transaction grouping control structure comprising one or more inheritance tag relationships and one or more container tag relationships.

FIG. 14 depicts an inter-system connection scheduler logic 1400 in one embodiment. The inter-system connection scheduler logic 1400 may be implemented for example in the scheduler 1016. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 1402, the inter-system connection scheduler logic 1400 identifies which data sources are being scheduled. This action may be carried out for example by the scheduler 1016 by way of the user interface logic 1008. This action may result in the identification of data to pull and from which of the disparate computer server systems that act as data sources.

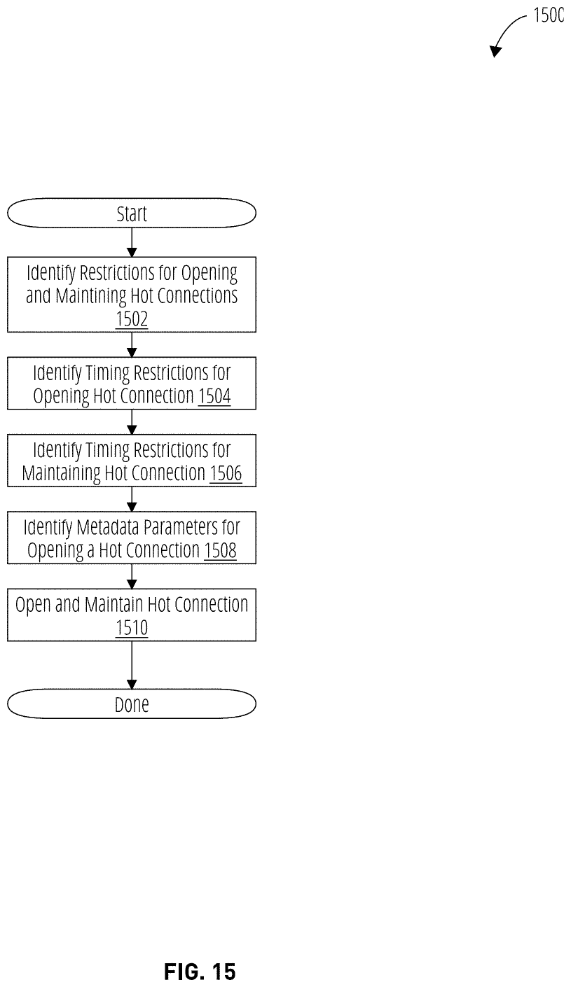

At block 1404, the inter-system connection scheduler logic 1400 identifies the cadence of the scheduled data. This action may be carried out by the scheduler 1016 and may be embodied in the cadence rules 1022. This action may result in invocation of a connection cadence setting logic 1500 as depicted in more detail in FIG. 15.

At block 1406, the inter-system connection scheduler logic 1400 initiates ingest of data as per the cadence rules 1022. This action may be carried out by the web service integration 1018 by way of the hot connection module 1024. This action may result in data being pulled and stored from various banking of the disparate computer server systems through dynamic API connections managed by the hot connection module 1024 according the scheduler 1016 and the cadence rules 1022.

At decision block 1408, the inter-system connection scheduler logic 1400 carries out a determination for the presences of a user override received from the connection cadence setting logic 1500. This test may be carried out by the scheduler 1016 and the cadence rules 1022. This determination results in identification of a user override or the absence of the user override. If a user override is detected, the inter-system connection scheduler logic 1400 returns to the block 1402 where the inter-system connection scheduler logic 1400 beings again by identifying the data to schedule. If a user override is not detected the process terminates. A user override may originate from a number of sources such as a system operator of the distributed resource management computing platform 1000, or a user of client logic such as the user interface logic 1008.

FIG. 15 depicts connection cadence setting logic 1500 in one embodiment. The connection cadence setting logic 1500 may be operated to set cadence for pulling data from disparate computer server systems in accordance with their access and security protocols. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 1502, the connection cadence setting logic 1500 identifies availability restrictions for establishing the hot connections. This action may be carried out in accordance with the cadence rules 1022 by hot connection module 1024. This action results in the identification of data access availability.

At block 1504, the connection cadence setting logic 1500 identifies timing restrictions for opening hot connections and again is implemented by the hot connection module 1024 in accordance with the cadence rules 1022. This action results in the identification of timing restrictions such as required intervals between connections or permissible or blackout connection times for institution-specific security protocols—OATH, tokenized, dual authentication etc.

At block 1506, the connection cadence setting logic 1500 identifies timing restrictions for maintaining hot connections and again is implemented by the hot connection module 1024 in accordance with the cadence rules 1022. This action results in the identification of timing restrictions such as timeout intervals and restrictions on connection duration for institution-specific security protocols—OAuTH, tokenized, dual authentication etc.

At block 1508, the connection cadence setting logic 1500 (e.g., the hot connection module 1024) identifies metadata parameters for opening and establishing a hot connection. This action results in the identification of connection protocol and API-specific parameters, including authentication and authorization parameters, for opening and maintaining a hot connection.

Following block 1508, the connection cadence setting logic 1500 moves to block 1510 where the connection is established and maintained by the hot connection module 1024 and scheduled data pulls are made from the disparate computer server systems.

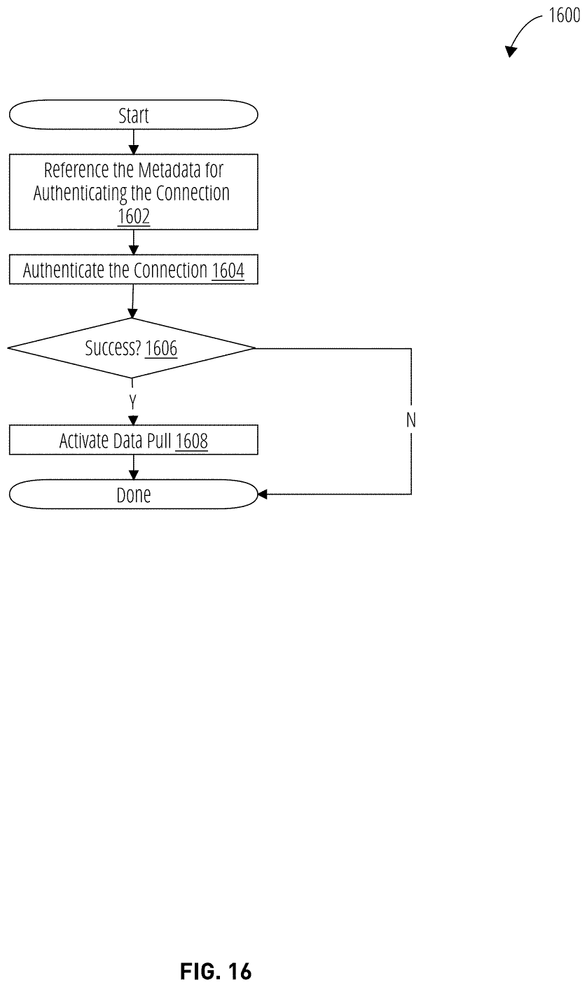

FIG. 16 depicts hot connection logic 1600 in one embodiment. The hot connection logic 1600 establishes and maintains hot connections with external disparate computer server systems. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 1602, the hot connection logic 1600 references the connection type and API metadata to begin authentication and authorization with one of the disparate computer server systems. This action and subsequent ones of the hot connection logic 1600 would typically be carried out by the hot connection module 1024 in accordance with the cadence rules 1022. At block 1604, the hot connection logic 1600 utilizes the metadata to authenticate/authorize and establish a connection with the external system.

At decision block 1606, the hot connection logic 1600 determines whether the connection was successfully established. If the determination identifies that the connection was successful, the hot connection logic 1600 moves to block 1608 where the data pull is activated. If the connection was not successful, the process either terminates or retries the establishment of the connection.

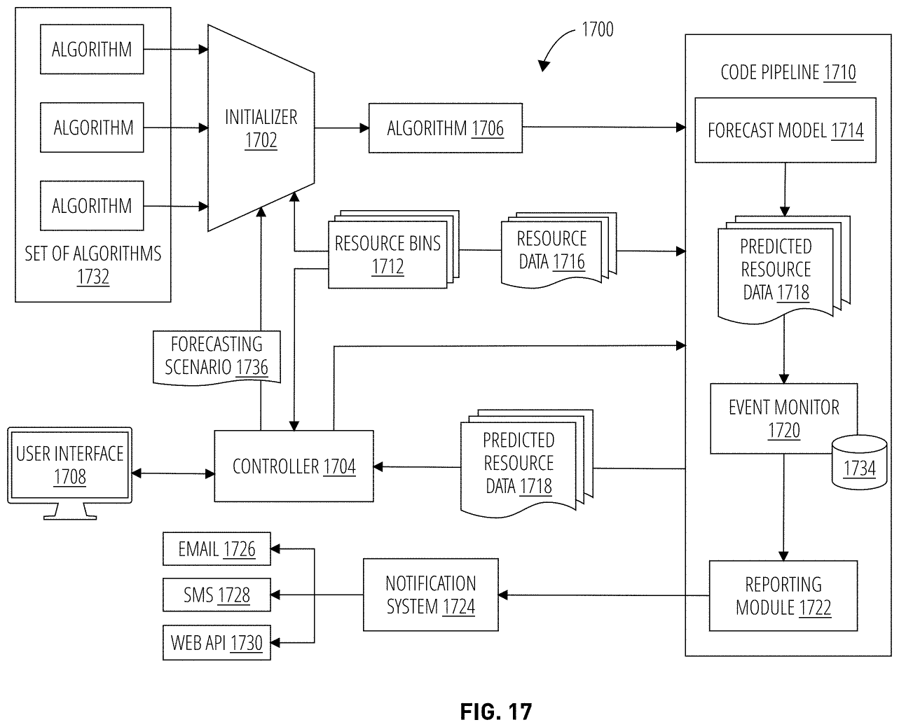

FIG. 17 depicts a resource forecast module 1700 in one embodiment. The resource forecast module 1700 comprises a user interface 1708, a controller 1704, an initializer 1702, a code pipeline 1710, and a notification system 1724. A user communicates a forecasting scenario 1736 for a particular resource bin of the resource bins 1712 for a specified time range. The forecasting scenario 1736 and time range are applied to the initializer 1702, which selects an algorithm 1706 from a set of algorithms 1732 to generate a forecast model 1714 for the resource bin during the time range. The selected algorithm 1706 is executed in a code pipeline 1710 to generate the forecast model 1714.

The algorithms may comprise any demand and/or flow modeling algorithm known the art for modeling resource inflow and outflow behavior in an organization. The selected algorithm will depend on the nature of the resource to model and the scenario. For example there exist many financial modeling algorithms that may be selected based on the provided forecasting scenario 1736. Likewise there exist many modeling algorithms for bandwidth consumption, computing power consumption, energy consumption, water consumption, equipment requirements to meet operational goals, and so on. These algorithms may be parameterized in manners known in the art. To select the algorithm 1706, the initializer 1702 may perform a best fit between attributes of the forecasting scenario 1736 and parameters of each algorithm in the set of algorithms 1732.

The forecast model 1714 utilizes the resource data 1716 from the resource bins 1712 to generate predicted resource data 1718 for the selected one of the resource bins 1712 for the future time range. The predicted resource data 1718 is provided to the controller 1704 which communicates the predicted resource data 1718 to the user interface 1708. The predicted resource data 1718 is also utilized by an event monitor 1720 in the code pipeline 1710 that compares the predicted resource data 1718 to triggers in a trigger database 1734. The triggers are values and conditions (e.g., changes in values over time, etc.,), and combinations thereof configured in the system and associated with an alert. When the event monitor 1720 detects a trigger in the predicted resource data 1718, an alert is generated and communicated to a reporting module 1722. The reporting module 1722 communicates the alert to the notification system 1724 which distributes the alert to one or more of a plurality of notification routes comprising, for example, email 1726, SMS 1728, and a Web API 1730.

In some configurations, the algorithms in the set of algorithms 1732 may be determined based on the characteristics of the forecasting scenario 1736. For example, characteristics of the resource data in the resource bins 1712 such as the data type, data range, time of the year that the scenario is being generated, etc., may be utilized in selecting a set of algorithms 1732 for the initializer 1702. The characteristics of the future time range may also be utilized to determine the set of algorithms 1732. For example, the future time range may be set to generate predictions in six weeks, three months, six months, or twelve months in the future. This future time range may be utilized by the initializer 1702 in determining the initial set of algorithms and/or selecting the algorithm 1706.

In some configurations, the selection process utilized by the initializer 1702 may determine an algorithm from the set of algorithms 1732 utilizing a competitive technique, by comparing models generated by the set of algorithms 1732 to resource data from the resource bins. The initializer 1702 may take historical resource data or generate synthetic historical resource data and generate forecast models for each of the algorithms. The historical resource data may be selected based on similarities to the forecasting scenario 1736 such that the size of the resource data and size of the future time range are similar, where the future time range is utilized to determine actual resource data values. The synthetic historical resource data may be generated with similarities to the forecasting scenario 1736, such as similarities in the size of the resource data and the future time range. The initializer 1702 may then compare predicted resource data generated from the forecast models to actual resource data values found in the resource bins 1712. The initializer 1702 may evaluate the predicted resource data from the each of the algorithms and determine an error score based in part on the comparison to the actual resource data values. The evaluation process may also include an error threshold where models generating error values exceeding the threshold are automatically disqualified from being selected by the initializer 1702. The initializer 1702 may then select an algorithm based at least in part on the error value and communicate the decision to the code pipeline 1710.

In some configurations, the algorithms in the set of algorithms 1732 may be selected based on recursive evaluation of the algorithms by the initializer 1702. For example, algorithms that are determined to exceed the error threshold during the evaluation done by the initializer 1702 may be excluded from the set of algorithms 1732 in future forecasting sessions. In some configurations the algorithms utilized may be support vector machine, gradient boost, a combination of stochastic gradient descent and random forest, and similar algorithms.

In some configurations, the alert communicated by the notification system 1724 comprises a report detailing the incident that triggered the alert. The report comprises a description of the trigger presented in context of the predicted resource data. The trigger description includes threshold values or event information for the resource data and the context identifies the resource bin and the time range in which the resource data could potentially exceed the threshold values or exhibit the features of a trigger event. This information is communicated through the plurality of notification routes.

In some configurations, the resource forecast module 1700 operates in real time such that the selection of the algorithm 1706, the generation of the model and the predicted results, and the communication of the alerts occurs within a configured threshold performance interval (e.g., 200 milliseconds) following the submission of the forecasting scenario 1736. The resource forecast module 1700 may operate on a server-less runtime where requests, for example the forecasting scenario 1736, are fulfilled with low latency. The resource forecast module 1700 may incorporate real-time payment (RTP) rails in conjunction with real time decisioning points that are implemented by the selected forecast model 1714 to output to the code pipeline 1710. An RTP rail, as is known in the art, is similar to Automated Clearing House (ACH) payment rail systems but operates through an API providing faster feedback to a resource provider institution for updating resource data. This allows for lower latency access to data for processing by the initializer 1702.

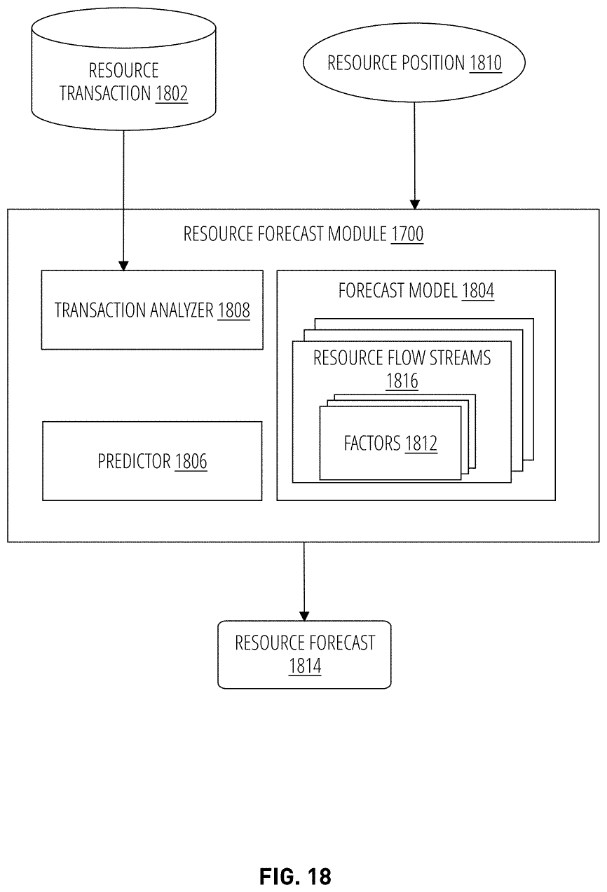

FIG. 18 depicts additional aspects of the resource forecast module 1700 in accordance with one embodiment. The resource forecast module 1700 comprises a transaction analyzer 1808, a predictor 1806, and a forecast model 1804 comprising one or more resource flow streams 1816. Each resource flow stream comprises one or more factors 1812. The resource forecast module 1700 utilizes a resource position 1810 and a set of resource transactions 1802 to determine a resource forecast 1814.

The transaction analyzer 1808 may determine a relationship between one or more historical resource transactions 1802 and one or more resource flow streams 1816. The transaction analyzer 1808, in certain embodiments, may determine how one or more resource transactions affects the one or more resource flow streams 1816.

The transaction analyzer 1808 may identify a particular set of resource transactions based on a name or description for the transaction(s) (e.g., payroll, inventory, etc.,), the source of the transaction (e.g., resource provider institution, EPR system, etc.,) as well as other identifiable metadata associated with the particular transactions. In addition, the transaction analyzer 1808 may further identify transactions to associate with a resource flow stream by a tag associated with an existing stream such that a resource flow stream may include resource transaction 1802 associated with more than one resource flow stream.

The predictor 1806 may project a future resource flow for each of the one or more resource flow streams 1816 based on the relationship between a resource transaction 1802 and the resource flow stream 1816. The predictor 1806 may project a resource flow stream value at a time in the future, provided that each associated factor occurs between not and that time in the future. In one embodiment, the predictor 1806 employs and/or comprises a neural network. In certain embodiments, the neural network used may be pre-trained. In other embodiments, the neural network used may train based on resource transaction available to the predictor 1806 and feedback from a user. Neural network architectures and training techniques for producing predictions/classifiers for resource flows are known in the art.

The one or more factors 1812 associated with each of the resource flow stream 1816 may be utilized to adjust the projected future resource flow from each resource flow stream 1816. The one or more factors 1812 associated with a resource flow stream describe a behavior within a resource flow stream, such as a change in the inflow or outflow of a resource of interest during a period of time. The behavior may be associated with an event such as the release of a new product, and the tracked change could be a change in revenue that directly correlates with the sale of the new product. By including factors, the predictor 1806 may be able to adjust the resource flow stream to account for the changes and improve the predicted future resource flow for each resource flow stream.

The factors may also be configured to account for rate changes such as a percentage change factor. A percentage change factor is a factor configured to change the resource flow for a resource flow stream by a predetermined percentage over time with a predefined frequency. For example, in one embodiment, the percentage change factor comprises a percentage increase, for example, 0.025%, with a frequency interval, such as each future pay period or every three days. In another example, in one embodiment, the percentage change factor comprises a percentage decrease, for example, 0.025%, with frequency interval, such as each seven days. The factors may also be configured to account for expected time shift changes for certain behaviors through a time shift factor.

In certain embodiments, the user interface 1902 may include an editor (not shown) for a user to use to define, edit, revise, copy, and delete forecast models 1804. In one embodiment, the forecast model 1804 comprises logic configured to project how the one or more factors 1812 impact one or more resource flow streams 1816 based on the resource transactions 1802. In one embodiment, the forecast model 1804 comprises a set of transaction streams and relations between them and factors that influence how the forecast model 1804 changes in view of different transactions or other input information.

The forecast model 1804, in one embodiment, may project an impact of future resource flows for each of the resource flow streams 1816. The predictor 1806 may then combine the resource flow predictions into the forecast model 1804 for one or more of the resource flow streams 1816. The predictor 1806 may utilize the resource position 1810 as a current resource position and generate a resource forecast 1814 based thereon, using the forecast model 1804. The resource forecast 1814 describes the future resource flow for the selected resource flow stream 1816 including the adjustments based on each associated one or more factors 1812 relative to a current resource position.

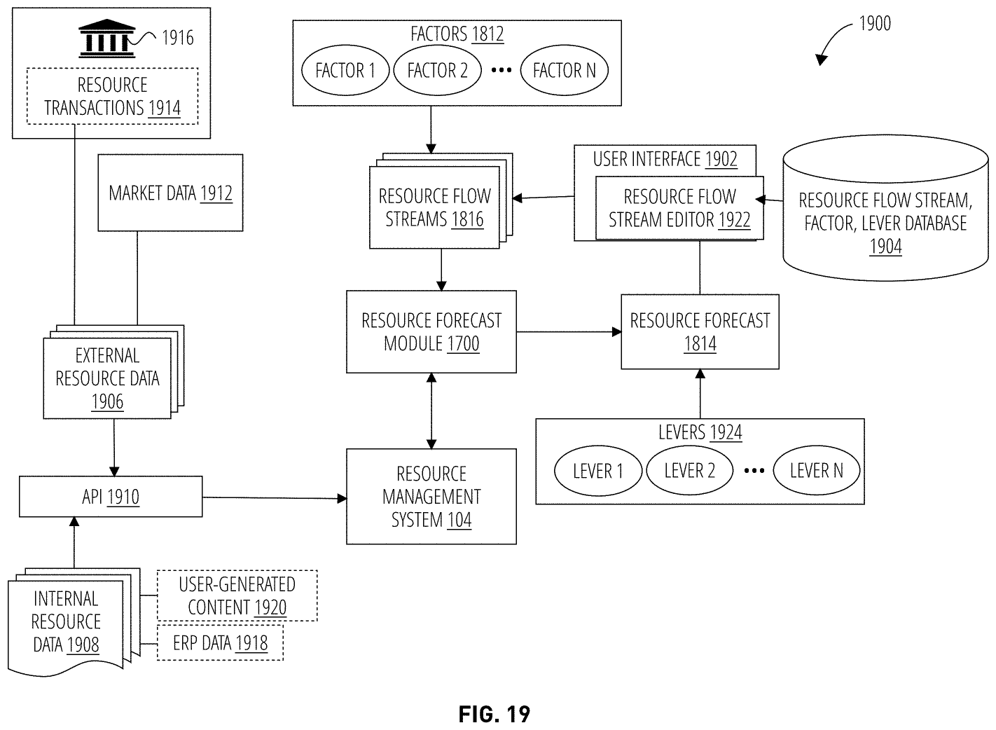

FIG. 19 depicts a resource forecasting system 1900 in accordance with one embodiment. The resource forecasting system 1900 comprises a resource management system 104, a resource forecast module 1700, a user interface 1902, and a resource flow stream, factor, lever database 1904.

The resource management system 104 may comprise any hardware, circuit, component, module, logic, device, or apparatus configured, programmed, designed, arranged, or engineered to manage, combine, and operate on account transaction data, market data, and company system data each accessible using application programming interfaces (APIs) to analyze transactions and provide resource level metrics for a company. The resource management system 104 receives external resource data 1906 and internal resource data 1908 through an API 1910. The external resource data 1906 comprises market data 1912 and resource transactions 1914 from at least one resource provider institution 1916. The internal resource data 1908, in one embodiment, comprises ERP system resource data 1918 and user-generated content 1920, such as spreadsheet data.

The resource management system 104 may determine a resource position for a company based on at least resource transactions 1914 and ERP system resource data 1918. The resource management system 104 communicates the resource position to the resource forecast module 1700.

The resource forecast module 1700 generates a resource forecast 1814. In one embodiment, the resource forecast module 1700 may use a resource flow stream 1816 to generate the resource forecast 1814.

The resource forecast module 1700 may comprise any hardware, circuit, component, module, logic, device, or apparatus configured, programmed, designed, arranged, or engineered to determine a resource forecast 1814. The resource forecast 1814, in one embodiment, comprises a projection, or an estimate, of the timing and amounts of resource inflows and outflows over a specific time period. In some instances, the forecast or projection may predict inflows and outflows over a period of a month, quarter, and/or year. The resource forecast 1814, is useful for decision makers to decide if a company needs to borrow, lease, or purchase, how much, when, and on what terms. A resource flow forecast may also be called resource flow budget or resource flow projection.

The resource forecast module 1700, in one embodiment, generates a resource forecast 1814 based on the resource position and one or more resource flow streams 1816, each resource flow stream may represent a resource flow for one aspect of the company, and each resource flow stream may comprise one or more factors, each factor configured to affect an associated resource flow stream in the future.

The user interface 1902 enables a user to view, review, or edit a resource forecast 1814, a resource flow stream 1816, or adjust or revise resource forecasts. The user interface 1902 may provide a user access to a resource flow stream editor 1922. The user interface 1902 may also include a graphical user interface configured to display information to the user to help them to access, configure, control, execute, or terminate a resource forecast 1814, a resource flow stream 1816, one or more factors 1812, and/or one or more levers 1924. The resource flow stream editor 1922 enables a user to select a resource flow stream 1816 as well as one or more factors 1812 associated with the resource flow stream 1816 to be utilized by the resource forecast module 1700.

In one embodiment, a user may design, configure, build, or edit a consolidated resource forecast. A consolidated resource forecast is a combination of one or more resource forecasts. The user interface 1902 provides the user with a variety of options for working with resource forecasts. In one embodiment, a user may copy or duplicate an existing resource forecast to create a new resource forecast and alter various attributes and/or characteristics of the new resource forecast. For example, a user may add, remove, or modify one or more levers relating to the new resource forecast. The levers may affect a resource forecast at a macro level.

In one embodiment, a resource flow stream, factor, lever database 1904 may comprise a data structure that allows for storage, access, modification, and retrieval of data corresponding to a plurality of resource flow streams 1816 as well as the one or more factors 1812 associated with each resource flow stream 1816 accessible by the user through the user interface 1902. The resource flow stream, factor, lever database 1904 may also include zero or more levers (e.g., one or more levers 1924) that associate with one or more resource forecasts 1814. The resource flow stream, factor, lever database 1904 may be configured to assist a user in identifying a resource flow stream 1816 and in identifying one or more factors 1812 from various sources including external resource data 1906 and internal resource data 1908 to be utilized by the resource management system 104. The resource flow stream, factor, lever database 1904 may also track and store associations between resource flow streams 1816 and one or more factors 1812 and resource forecasts 1814 and one or more levers 1924.

In the resource forecasting system 1900, the user interface 1902 configures a resource flow stream 1816 for use by the resource forecast module 1700 through a resource flow stream editor 1922. The resource flow stream editor 1922 allows users to select, define, and/or edit cash streams and factors for a generating a resource forecast 1814. In one embodiment, a user may generate the resource flow stream and/or factors from scratch. In another embodiment, one or more of the resource flow streams and/or factors may come from the resource flow stream, factor, lever database 1904.

Each resource flow stream 1816 may represent a resource flow for one aspect of the company. In one embodiment, each resource flow stream comprises, or is associated with, one or more factors 1812. A factor may be configured to affect an associated resource flow stream in the future, depending on what attributes or characteristics the factor relates to. In one embodiment, the one or more factors 1812 associated with a resource flow stream describe a behavior in a resource flow stream 1816 such as a change in the inflow or outflow of resources during a period of time. The behavior may be associated with an event such as the release of a new product and the tracked change could be a change in revenue that directly correlates with the sale of the new product. By including factors, the resource forecast module 1700 may adjust the resource flow stream to account for the changes over time and thereby improve a resource forecast 1814.

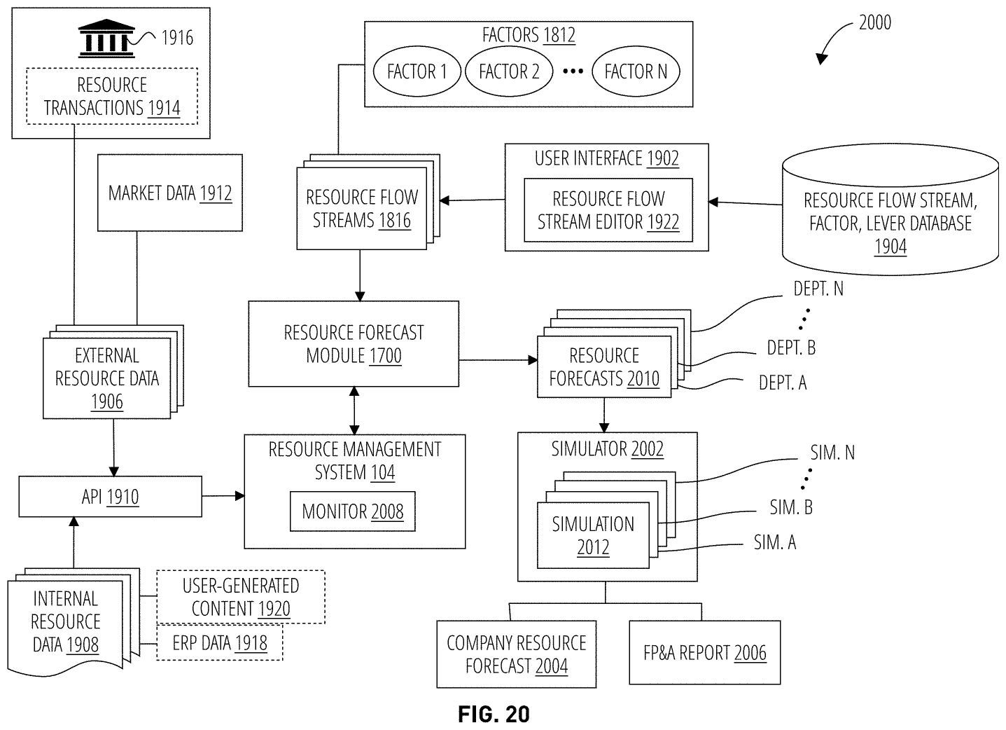

FIG. 20 depicts a resource forecasting system 2000 in accordance with one embodiment. The resource forecasting system 2000 comprises components in common with the resource forecasting system 1900, and additionally a simulator 2002 to transform resource forecasts 2010 into simulations 2012 and generate a company resource forecast 2004 and an FP&A report 2006. Additionally, the resource management system 104 of the resource forecasting system 2000 further comprises a monitor 2008.

The resource forecast module 1700 may communicate with the resource management system 104 to retrieve resource position data and resource transactions that correspond to the one or more resource flow streams 1816. The resource forecast module 1700 may generate the plurality of resource forecast 2010. In the depicted configuration, the resource management system 104 includes a monitor 2008. The monitor 2008 may identify resource flow streams 1816 from resource transactions collected by the resource management system 104. Alternatively, or in addition, the resource forecast module 1700 may include the monitor 2008. In one embodiment, the monitor 2008 uses tags to identify resource flow streams 1816.

The resource forecast module 1700 provides the plurality of resource forecasts 2010 to a simulator 2002. The simulator 2002 may combine the plurality of resource forecasts 2010 into a simulation 2012 and generate a company resource forecast 2004 based on the plurality of resource forecasts 2010. The simulator 2002 may generate a plurality of simulations from one or more resource forecasts 2010. In certain configurations, the simulator 2002 may generate an FP&A report 2006 from the one or more resource forecasts 2010.

In certain embodiments, the resource forecasting system 2000 may include a processor and a volatile memory media storing instructions that, when executed by the processor, cause the processor to perform certain operations. The instructions may cause the processor to retrieve historical resource transaction from a prior day over a network by way of an application programming interface (API 1910) from a one or more of a resource provider institution 1916 for each resource account of the company, and internal resource data 1908 such as resource data from an enterprise resource planning (ERP) system, and user-generated content such as transaction records from an spread sheet.

The processor may be instructed to determine a relationship between historical resource transactions and a resource flow stream for a specific part of a company as defined by, or in, a forecast model, such as forecast model 1804. The forecast model may include one or more resource flow stream 1816 where each of the resource flow streams may include one or more one or more factors 1812. The processor may be instructed to predict one or more future resource flows for the one or more resource flow streams defined by the forecast model by applying the relationship.

The processor may be instructed to generate a direct method generated resource forecast for a predefined future time period (e.g., next quarter, or next year) based on a direct method of financial resource flow process using the one or more future resource flows. The processor may be instructed to present the direct method generated resource forecast to a user.

In certain embodiments, the resource forecasting system 2000 may display a revised direct method generated resource forecast in response to a daily change in one or more of historical resource transactions, ERP system resource data, and user-generated content.

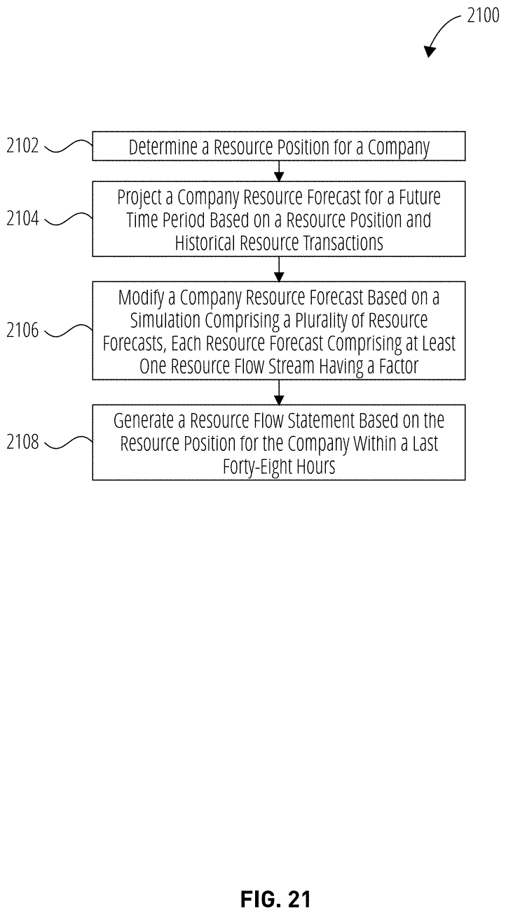

FIG. 21 depicts a method 2100 in accordance with one embodiment. In step 2102, the method 2100 determines a resource position for a company. In step 2104, the method 2100 projects a company resource forecast for a future time period based on the resource position and historical resource transactions. In step 2106, The method 2100 modifies the company resource forecast based on a simulation comprising a plurality of resource forecasts, each resource forecast comprising at least one resource flow stream having a factor. In step 2108, the method 2100 generates a resource flow statement based on a resource position for the company within the last forty-eight hours.

In some configurations, a step 2104 of projecting the company resource forecast may include gathering historical resource transactions from resource provider institutions, and ERP system resource data from ERP systems. Step 2104 may include modifying the resource position for the company on the basis that the future resource flows are directly correlated with past resource flows that generated the resource position. In some configurations, the resource flow stream may include a resource uses stream. In some configurations, the resource flow stream may include a resource sources stream.

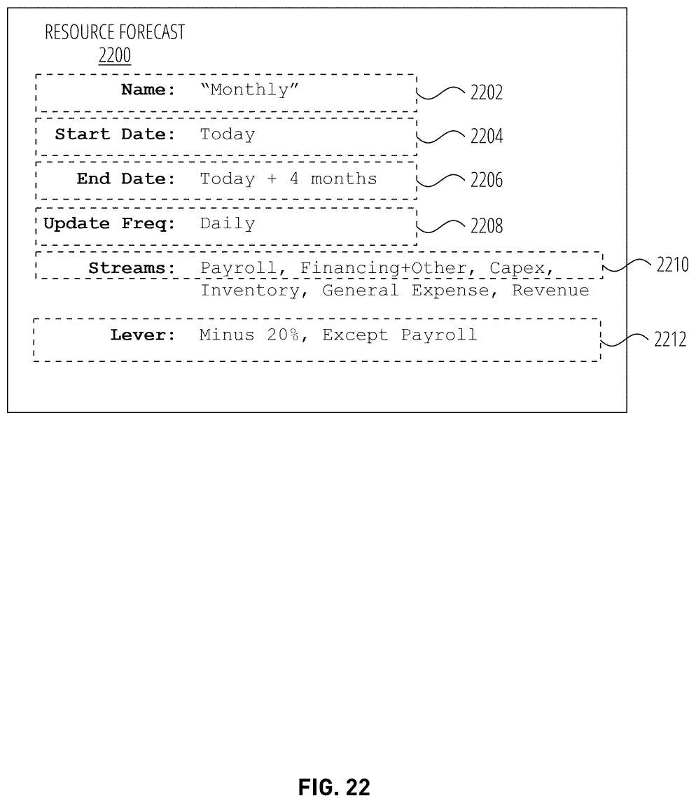

FIG. 22 depicts a resource forecast 2200 in accordance with one embodiment. The resource forecast 2200 defines factors associated with reach resource flow stream. The resource forecast 2200 comprises a forecast name 2202, a start date 2204, an end date 2206, an update frequency 2208, and at least one resource flow stream 2210.

The forecast name 2202 may be a description of a time period that a user wishes to view or another name that a user wishes to assign. For instance, a user may name the forecast name 2202 after an applicable month or fiscal quarter to allow easy identification of the forecast when searched or reviewed. The start date 2204 and the end date 2206 are the date ranges for generating the resource forecast 2200, for instance the start date 2204 in the resource forecast 2200 indicates that start of the range is “today” and the end of the range is “today+4 months” indicating that the range is 4 month range. The start date 2204 and end date 2206 may be used by a resource forecast module 1700 to determine which historical resource transactions are applicable to a particular resource forecast 2200.

The update frequency 2208 is the interval by which the forecast information updates the collected resource data. In some instances, the information may be updated based on the data collected from the resource management system 104 or updated based on changes from the user interface 1902. In some instances, the update frequency 2208 updates the forecast model 1804 with the updated financial information.

The resource flow stream 2210 identifies one or more resource flow streams in the historical resource transaction data from to use for generating a resource forecast 1814. Examples of resource flow streams that may be included in a resource forecast 2200 are: a payroll stream, a financing stream, a capex stream, an inventory stream, a general expenses stream, a revenue stream, a leasehold income stream, and the like. In certain embodiments, a resource forecast 2200 may include one or more resource flow streams. In another embodiment, a resource forecast 2200 may include no resource flow streams 2210.

A resource forecast 2200 may include no levers 2212, or may include one or more levers 2212. The levers 2212 represent a macro level characteristic that influences or is related to the resource forecast 2200.

A lever is similar to a factor with the main difference that, in one embodiment, a lever affects each resource flow stream and each factor that a resource forecast may have. In another embodiment, a lever may affect one or more resource flow streams and one or more factors of a resource forecast. A lever is a condition, criteria, or attribute setting that a user may configure on a resource forecast. Levers enable the configuration of new or revised resource forecasts that model the impact of a particular lever.

For example, suppose an external event or condition (also referred to as a business scenario) in a particular geographic region, industry, or sector exists or has a high risk of occurring in the future. The event or condition could be a negative or a positive influence on resource flow for a business. Suppose the event or condition represents a recession risk, a negative influence on resource flow, a team (one or more users) may want to execute scenarios to understand the impact on resource levels and liquidity in the event that overall business decreases by 20%. Such a resource forecast may facilitate a determination of how deep to cut into certain operations.

To determine such a resource forecast, a user may setup or configure a specific “lever” defined, for example, to state “minus 20%, except payroll.” Such a lever would then calculate and adjust down all non-payroll streams within the resource forecast by 20%. This permits a finance team to quickly model out a scenario, defined by the lever setting, without configuring many factors applied to each individual stream within the resource forecast.

In another example, suppose a company is anticipating a loss of $50M over the next year and has only had $30M in the bank. Such a company could define a lever to adjust a resource forecast at a macro level or a certain period of time to model the resource position in the future. Such a resource forecast may help the business determine operational adjustments in order to keep the company solvent.

Levers provide an easy macro level way for resource forecasts to take account of macro level adjustments. A user can adjust a lever to see a resource forecast based on a positive resource flow or negative resource flow impact the impact from changes to 10%, then 15%, then 20%, etc. The adjustments are reflected in the resource forecast and associated consolidated resource metrics.

In one embodiment, a set of levers may be predefined. In another embodiment, a user may edit predefined levers. In another embodiment, a user may define levers that reflect the changes specific to the user's needs.

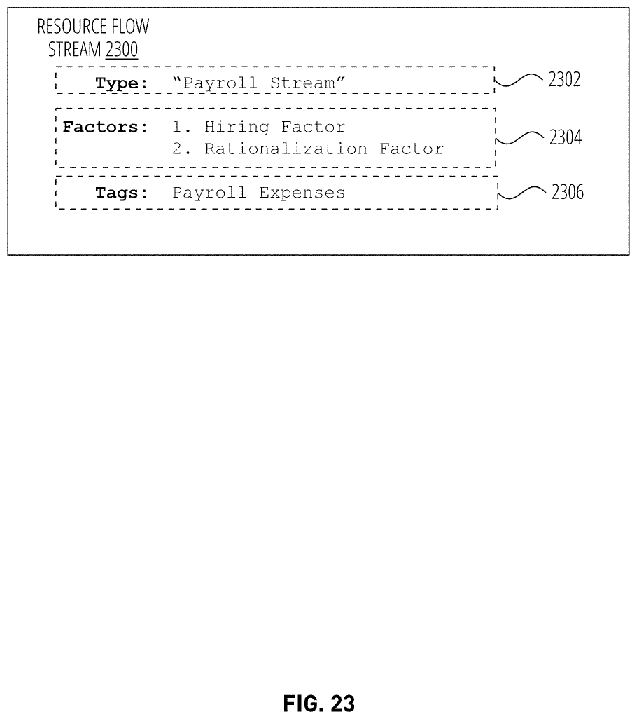

FIG. 23 depicts a resource flow stream 2300 in accordance with one embodiment. The resource flow stream 2300 identifies a category of resource data collected by a resource management system 104 to be utilized to generate the resource forecast, among other uses. In some instances, a user enters assumptions for the resource forecast by configuring the one or more resource streams for a specific part of a company.

The resource flow stream 2300 comprises a resource flow stream type 2302 may include one or more factors 2304. The resource flow stream type 2302 indicates the category of resource data, or business activity, or part of a company, to be utilized to generate the resource forecast. For instance, “payroll stream” indicates that the resource flow stream to be utilized corresponds to payroll related resource flows. Other types of resource flow streams 2300 may include an “power stream”, a “bandwidth stream”, an “OpEx stream”, and so on.

The one or more factors 2304 may parameterize potential conditions, restrictions, limitations, presumptions, and/or assumptions, that may affect the resource flow associated with the stream. For instance, the example factors 2304 may include a hiring factor and a rationalization factor that may each modify the resource flow of the resource flow stream during a resource forecast time period. The hiring factor defines a potential change in the resource flow of the stream, as new hires are brought into the company. Each new hire would increase certain expenses associated with payroll, for example, and each layoff would affect capacity of design resources for engineering, potentially. The rationalization factor may affect the resource flow stream 2300 as reorganization actions of the company may lead to an expansion, or reduction, in the work force, thus an increase, or decrease, in expenses and operational capacity. In certain embodiments, a resource flow stream 2300 may include no factors. In one aspect, a resource flow stream 2300 with no factors may be used in a resource forecast as a standalone resource flow stream. Later a user may or may not add a factor to a resource flow stream without any factors. A resource flow stream 2300 without a factor may capture natural influences on the resource flow stream 2300 without applying a particular factor.

In some configurations, the resource flow stream 2300 may include a tag 2306. The tag 2306 may be an identifier corresponding to a named search parameter or metadata parameter utilized by the resource management system 104 to classify certain resource transactions. The resource forecast 1814 may use a tag 2306 to identify resource transactions associated with the resource flow stream. For instance, the tag 2306 indicates “Payroll Expenses” which may indicate the named search parameter for the resource management module to use to identify a particular class of resource transaction associated with the payroll stream. The resource flow stream 2300 may include a combination of resource source transactions and resource use transactions. A tag 2306 may be used to include both resource source transactions and resource use transactions. For example, a resource flow stream 2300 may include two tags 2306, one associated exclusively with drains on a resource (e.g., resource use transactions) and one associated exclusively with enhancements to a resource (e.g., resource source transactions).

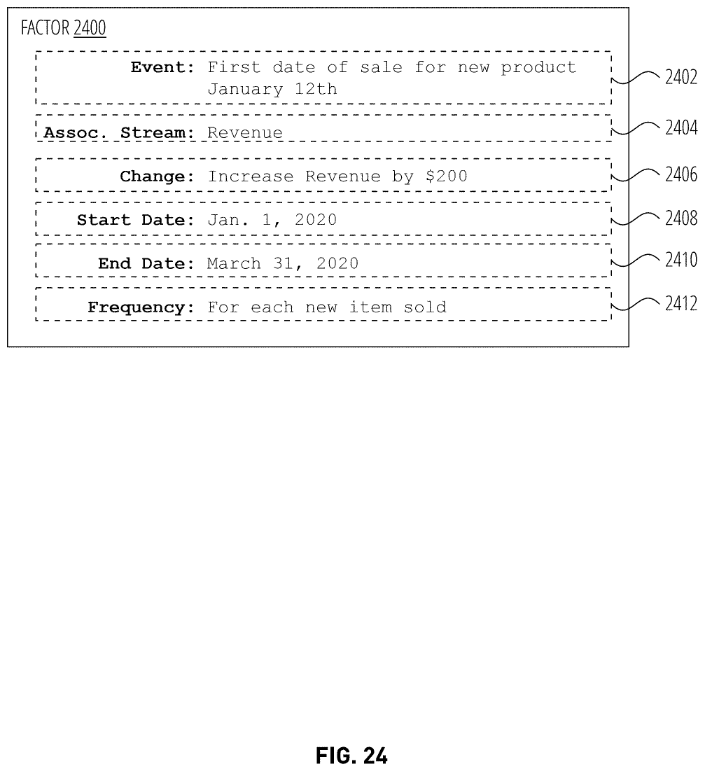

FIG. 24 depicts one example of a factor 2400 in accordance with one embodiment. The factor 2400 may be a collection of parameters, settings, or values that impact a resource flow of at least one steam. The factor 2400, in one embodiment, includes an event 2402, at least one associated resource flow stream 2404, a change 2406, a start date 2408, an end date 2410, and a frequency 2412.

The event 2402 may describe a future event that may modify the resource flow of at least one particular resource flow stream. For instance, the event 2402 may describe a future first date of sale for a new product and indicate that date of the event is January 12th. In one embodiment, a date in the event 2402 description may be used by the resource forecast module 1700 to determine whether or not a particular factor 2400 applies. In another embodiment, the event 2402 may be a text description and the resource forecast module 1700 may use the start date 2408 to track when to apply a particular factor 2400.

The associated resource flow stream 2404 may indicate the resource flow stream affected by the future event. For instance, the associated resource flow stream 2404 describes “Revenue” as the resource flow stream affected by the event 2402.

The change 2406 is a parameter that defines how the resource flow stream, associated resource flow stream 2404, will change due to the factor 2400. In this example, the change 2406 is for an increase in revenue by $200. Alternatively, or in addition, the change may indicate a decrease in a value related to the resource flow. For example, the factor 2400 may be a cost factor and occurrence of the event may result in a decrease to cash on hand. The change 2406 may indicate the magnitude of the change explicitly or the magnitude may be derived from resource transaction referenced by the resource forecast module 1700. For example, sales of a product may be captured in a different factor and the amount of increase in revenue may be based on the sale price less a predefined cost of goods sold (COGS).

In certain factors, the change 2406 may be associated with a frequency 2412 of change (e.g., “for each new item sold”). The frequency 2412 may also be configured to a time period such as each month, or each week, or each quarter.

The start date 2408 and the end date 2410 may indicate a date range during which the change 2406 may occur, and/or when the factor 2400 is applicable. For instance, the start date 2408 indicates that the start of the range is Jan. 1, 2020, and end date 2410 is Mar. 31, 2020.

In some embodiments, the factor 2400 may include a percentage change factor that may impose a change on a resource flow stream resource position by a certain percentage with a certain frequency (e.g., frequency 2412).

For example, the change may be an increase or a decrease in total value of the resource flow stream by a defined percentage. In some configurations, the factor 2400 may include a time shift factor that may change a resource flow stream resource position by an amount based on an adjustment to when a resource transaction is to be completed.

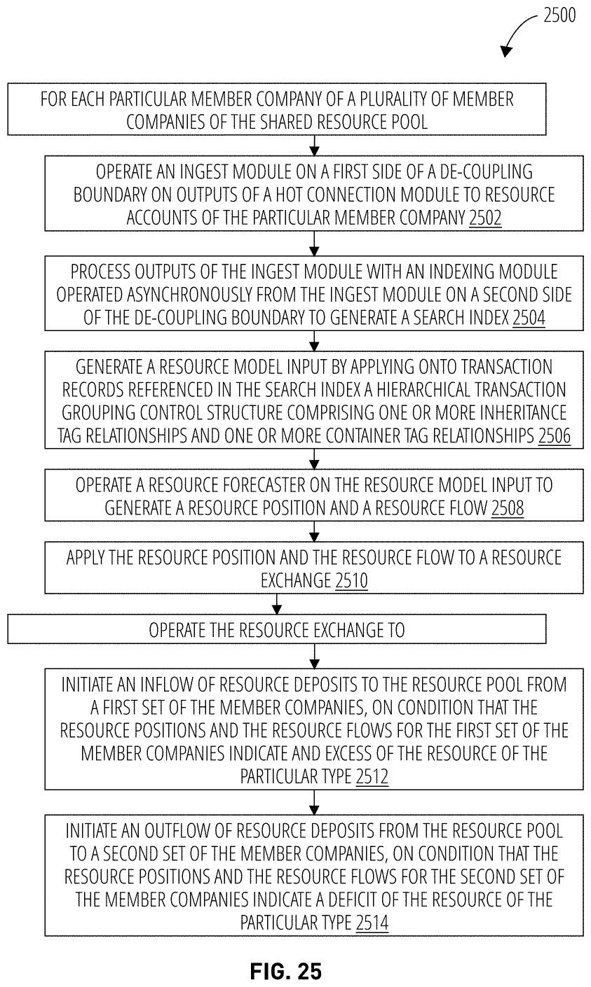

FIG. 25 depicts a process 2500 in one embodiment. For each particular member company of a plurality of member companies of the shared resource pool, the process 2500:

In block 2502, operates an ingest module on a first side of a de-coupling boundary on outputs of a hot connection module to resource accounts of the particular member company;

In block 2504, processes outputs of the ingest module with an indexing module asynchronously from the ingest module on a second side of the de-coupling boundary to generate a search index.

In block 2506, generates a resource model input by applying onto transaction records referenced in the search index a hierarchical transaction grouping control structure comprising one or more inheritance tag relationships and one or more container tag relationships.

In block 2508, operates a resource forecaster on the resource model input to generate a resource position and a resource flow. In block 2510, process 2500 applies the resource position and the resource flow to a resource exchange.

The resource exchange is then operated to:

In block 2512, initiate an inflow of resource deposits to the resource pool from a first set of the member companies, on condition that the resource positions and the resource flows for the first set of the member companies indicate and excess of the resource of the particular type.

In block 2514, initiate an outflow of resource deposits from the resource pool to a second set of the member companies, on condition that the resource positions and the resource flows for the second set of the member companies indicate a deficit of the resource of the particular type.

Embodiments of a serverless cloud computing platform may, in accordance with this disclosure, implement a shared resource pool for a resource of a particular type. Such a computing platform may include a resource management system with logic configured, for each particular member company of a plurality of member companies of the shared resource pool, to operate an ingest module on a first side of a de-coupling boundary on outputs of a hot connection module to resource accounts of the particular member company; process outputs of the ingest module with an indexing module asynchronously from the ingest module on a second side of the de-coupling boundary to generate a search index; and generate a resource model input by applying onto transaction records referenced in the search index a hierarchical transaction grouping control structure comprising one or more inheritance tag relationships and one or more container tag relationships.

The computing platform may further include a resource forecaster with logic configured to transform the resource model input into a resource position and a resource flow, and a resource exchange with logic configured to: receive the resource position and the resource flow; initiate an inflow of resource deposits to the resource pool from a first set of the member companies, on condition that the resource positions and the resource flows for the first set of the member companies indicate and excess of the resource of the particular type; and initiate an outflow of resource deposits from the resource pool to a second set of the member companies, on condition that the resource positions and the resource flows for the second set of the member companies indicate a deficit of the resource of the particular type.

The computing platform may further include logic configured to determine a credit profile for each particular company of the second set of member companies; and logic configured to apply repayment terms to the outflow of resource deposits to the particular company based on the credit profile for the particular company.

The computing platform may further include logic configured to credit an account of each member company having a positive balance in the resource pool with a pro rata share of an interest payment based on the outflow.

The computing platform may further include an application program interface to a resource provider institution for maintaining the resource pool, the application program interface enabling the resource provider institution to loan resources to the resource pool in response to a level of the resource pool falling below a configured threshold.

The computing platform may further include logic to configure triggers for initiating the inflows and the outflows.

The hot connection module of the computing platform may be responsive to a plurality of metadata control settings for disparate computer server systems, the control settings implementing cadence rules for connection to and data transfer from the disparate computer server systems. The hot connection module may be configured to execute a connection cadence on each of the disparate computer server systems based on the cadence rules.

The computing platform may include a serverless cloud computing platform with logic to determine the resource position based on at least resource transactions and ERP system resource data for the particular member company. The serverless cloud computing platform may further include logic to generate a resource forecast based on the resource position and one or more resource flow streams of the resource flow for the particular member company, each resource flow stream may include one or more factors. Each factor may include a percentage change factor configured to change a resource flow stream resource position by a percentage with a frequency. The factor may include a time shift factor configured to change a resource flow stream resource position by an amount based on changing a time that a resource transaction is to be completed.

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

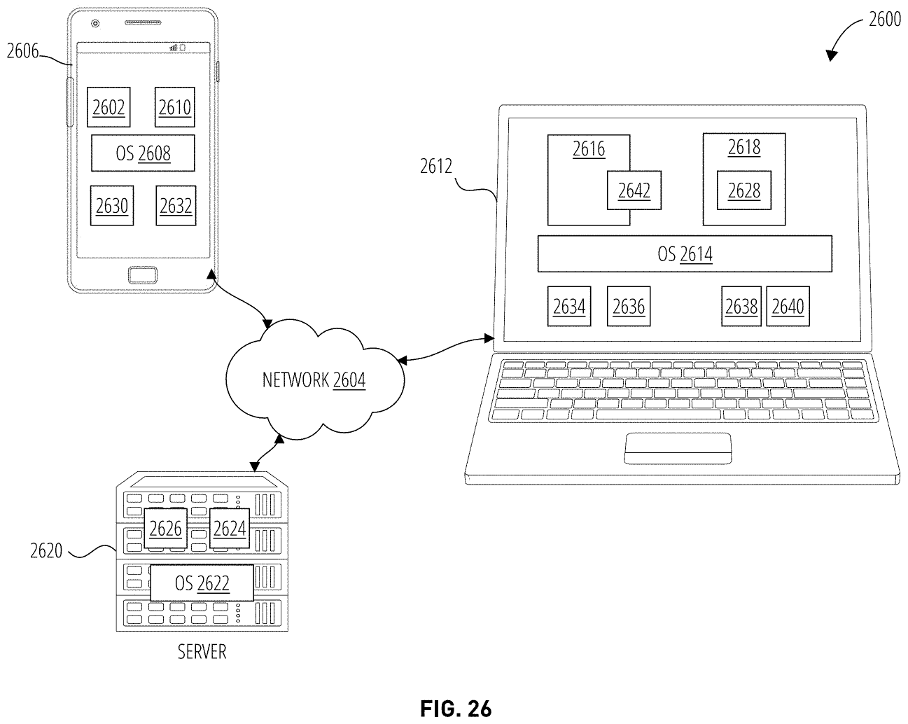

Referring to FIG. 26, a client server network configuration 2600 depicts various computer hardware devices and software modules coupled by a network 2604 in one embodiment. Each device includes a native operating system, typically pre-installed on its non-volatile RAM, and a variety of software applications or apps for performing various functions.

The mobile programmable device 2606 comprises a native operating system 2608 and various apps (e.g., app 2602 and app 2610), one or more of which may implement the the mobile application 1010 (e.g., as a mobile app). A computer 2612 also includes an operating system 2614 that may include one or more library of native routines to run executable software on that device. The computer 2612 also includes various executable applications (e.g., application 2616 and application 2618). The mobile programmable device 2606 and computer 2612 are configured as clients on the network 2604. A server 2620 is also provided and includes an operating system 2622 with native routines specific to providing a service (e.g., service 2624 and service 2626) available to the networked clients in this configuration. As previously noted, various components of the ingest module 1002 and/or outflow module 1004 may be implemented as such services.

As is well known in the art, an application, an app, or a service may be created by first writing computer code to form a computer program, which typically comprises one or more computer code sections or modules.

A compiler is typically used to transform source code into object code and thereafter a linker combines object code files into an executable application, recognized by those skilled in the art as an “executable”. The distinct file comprising the executable would then be available for use by the computer 2612, mobile programmable device 2606, and/or server 2620. Any of these devices may employ a loader to place the executable and any associated library in memory for execution. The operating system executes the program by passing control to the loaded program code, creating a task or process. An alternate means of executing an application or app involves the use of an interpreter (e.g., interpreter 2628).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 2630 or driver 2632 on the mobile programmable device 2606 or computer 2612 (e.g., driver 2634 and driver 2636) might enable wireless headphones to be used for audio output(s) and a camera to be used for video inputs. Any of the devices may read and write data from and to files (e.g., file 2638 or file 2640) and applications or apps may utilize one or more plug-in (e.g., plug-in 2642 which may implement plug-in 1014) to extend their capabilities (e.g., to encode or decode video files).

The network 2604 in the client server network configuration 2600 can be of a type understood by those skilled in the art, including a Local Area Network (LAN), Wide Area Network (WAN), Transmission Communication Protocol/Internet Protocol (TCP/IP) network, and so forth. These protocols used by the network 2604 dictate the mechanisms by which data is exchanged between devices.

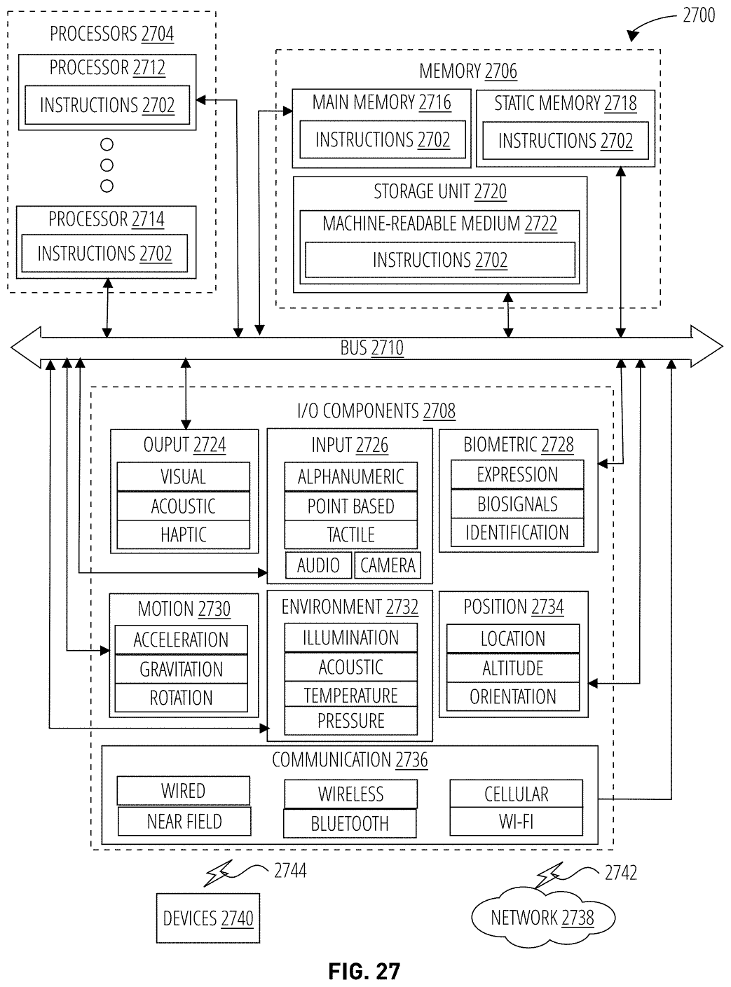

FIG. 27 depicts a diagrammatic representation of a machine 2700 in the form of a computer system within which logic may be implemented to cause the machine to perform any one or more of the functions or methods disclosed herein, according to an example embodiment.

Specifically, FIG. 27 depicts a machine 2700 comprising instructions 2702 (e.g., a program, an application, an applet, an app, or other executable code) for causing the machine 2700 to perform any one or more of the functions or methods discussed herein. For example, the instructions 2702 may cause the machine 2700 to implement the functionality described in conjunction with the distributed resource management computing platform 1000, control structure 1100, indexing module 1030, inter-system connection scheduler logic 1400, connection cadence setting logic 1500, and hot connection logic 1600. The instructions 2702 configure a general, non-programmed machine into a particular machine 2700 programmed to carry out said functions and/or methods.

In alternative embodiments, the machine 2700 operates as a standalone device or may be coupled (e.g., networked) to other machines. In a networked deployment, the machine 2700 may operate in the capacity of a server machine or a client machine in a server-client network environment, or as a peer machine in a peer-to-peer (or distributed) network environment. The machine 2700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 2702, sequentially or otherwise, that specify actions to be taken by the machine 2700. Further, while only a single machine 2700 is depicted, the term “machine” shall also be taken to include a collection of machines that individually or jointly execute the instructions 2702 to perform any one or more of the methodologies or subsets thereof discussed herein.

The machine 2700 may include processors 2704, memory 2706, and I/O components 2708, which may be configured to communicate with each other such as via one or more bus 2710. In an example embodiment, the processors 2704 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 2712 and processor 2714) to execute the instructions 2702. The term “processor” is intended to include multi-core processors that may comprise two or more independent processors (sometimes referred to as “cores”) that may execute instructions contemporaneously. Although FIG. 27 depicts multiple processors 2704, the machine 2700 may include a single processor with a single core, a single processor with multiple cores (e.g., a multi-core processor), multiple processors with a single core, multiple processors with multiples cores, or any combination thereof.

The memory 2706 may include one or more of a main memory 2716, a static memory 2718, and a storage unit 2720, each accessible to the processors 2704 such as via the bus 2710. The main memory 2716, the static memory 2718, and storage unit 2720 may be utilized, individually or in combination, to store the instructions 2702 embodying any one or more of the functionality described herein. The instructions 2702 may reside, completely or partially, within the main memory 2716, within the static memory 2718, within a machine-readable medium 2722 within the storage unit 2720, within at least one of the processors 2704 (e.g., within the processor's cache memory), or any suitable combination thereof, during execution thereof by the machine 2700.

The I/O components 2708 may include a wide variety of components to receive input, provide output, produce output, transmit information, exchange information, capture measurements, and so on. The specific I/O components 2708 that are included in a particular machine will depend on the type of machine. For example, portable machines such as mobile phones will likely include a touch input device or other such input mechanisms, while a headless server machine will likely not include such a touch input device. It will be appreciated that the I/O components 2708 may include many other components that are not shown in FIG. 27. The I/O components 2708 are grouped according to functionality merely for simplifying the following discussion and the grouping is in no way limiting. In various example embodiments, the I/O components 2708 may include output components 2724 and input components 2726. The output components 2724 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 2708 may include biometric components 2728, motion components 2730, environmental components 2732, or position components 2734, among a wide array of possibilities. For example, the biometric components 2728 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 2730 may include acceleration sensor components (e.g., accelerometer), gravitation sensor components, rotation sensor components (e.g., gyroscope), and so forth. The environmental components 2732 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2734 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2708 may include communication components 2736 operable to couple the machine 2700 to a network 2738 or devices 2740 via a coupling 2742 and a coupling 2744, respectively. For example, the communication components 2736 may include a network interface component or another suitable device to interface with the network 2738. In further examples, the communication components 2736 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 2740 may be another machine or any of a wide variety of peripheral devices (e.g., a peripheral device coupled via a USB).

Moreover, the communication components 2736 may detect identifiers or include components operable to detect identifiers. For example, the communication components 2736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2736, such as location via Internet Protocol (IP) geolocation, location via Wi-Fi® signal triangulation, location via detecting an NFC beacon signal that may indicate a particular location, and so forth.

The various memories (i.e., memory 2706, main memory 2716, static memory 2718, and/or memory of the processors 2704) and/or storage unit 2720 may store one or more sets of instructions and data structures (e.g., software) embodying or utilized by any one or more of the methodologies or functions described herein. These instructions (e.g., the instructions 2702), when executed by processors 2704, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

In various example embodiments, one or more portions of the network 2738 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 2738 or a portion of the network 2738 may include a wireless or cellular network, and the coupling 2742 may be a Code Division Multiple Access (CDMA) connection, a Global System for Mobile communications (GSM) connection, or another type of cellular or wireless coupling. In this example, the coupling 2742 may implement any of a variety of types of data transfer technology, such as Single Carrier Radio Transmission Technology (1×RTT), Evolution-Data Optimized (EVDO) technology, General Packet Radio service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 2702 and/or data generated by or received and processed by the instructions 2702 may be transmitted or received over the network 2738 using a transmission medium via a network interface device (e.g., a network interface component included in the communication components 2736) and utilizing any one of a number of well-known transfer protocols (e.g., hypertext transfer protocol (HTTP)). Similarly, the instructions 2702 may be transmitted or received using a transmission medium via the coupling 2744 (e.g., a peer-to-peer coupling) to the devices 2740. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 2702 for execution by the machine 2700, and/or data generated by execution of the instructions 2702, and/or data to be operated on during execution of the instructions 2702, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### LISTING OF DRAWING ELEMENTS

100 resource co-operative system
102 resource provider institutions
104 resource management system
106 system data
108 resource position
110 resource flow log
112 market data
114 treasury management
116 API
118 processor
120 volatile memory
122 user-generated content
124 resource flow statement
126 communication module
128 output module
130 controller
200 resource credit exchange system
202 resource provider institutions
204 resource forecast
206 resource credit exchange
208 company
210 collector
212 profiler
214 resource lenders
216 user-generated content
218 ERP system
300 resource management system
302 resource loan manager
304 transaction manager
400 resource credit exchange system
402 companies
404 resource credit exchange
500 credit profile
502 level 3
504 level 2
506 level 1
508 level 0
510 credit score
600 resource pooling co-operative system
602 resource pool
604 resource co-operative
606 resource exchange
608 resource provider institutions
610 resource forecaster
612 transaction manager
614 first set of member companies
616 second set of member companies
618 resource pool loan
620 resource deposits
622 resource
700 user interface
702 company's projected resource balance
704 inflows and outflows
706 optimal level of resource to be maintained
708 resource in excess
710 shortfalls
712 scenario
714 resource categories
716 indicator
718 chart
720 graph
722 selector
724 time range selector
726 snapshot button
800 user interface
802 amount
900 process
902 block
904 block
906 block
1000 distributed resource management computing platform
1002 ingest module
1004 outflow module
1006 de-coupling boundary
1008 user interface logic
1010 mobile application
1012 web application
1014 plug-in
1016 scheduler
1018 web service integration
1020 data storage and processing engine
1022 cadence rules
1024 hot connection module
1026 normalizing module
1028 raw data set
1030 indexing module
1032 arbitrator
1034 outflow engine
1036 meta-indexer
1038 alert generator
1040 tagging logic
1042 tag descriptor setting
1044 tag parameters
1046 metadata
1048 dynamic preview window
1050 index
1052 user application program interface
1100 control structure
1102 parent tag
1104 parent tag
1106 parent tag
1108 elemental tag
1110 elemental tag
1112 elemental tag
1114 exclusion tags
1202 queries
1204 search engine
1206 indexed transactions
1208 results
1210 control structure
1212 parameter tag
1214 term
1216 parameter
1218 combination tag
1220 parameter tag
1222 parameter tag
1224 combination tag
1226 exclusion tag
1228 parameter tag
1230 parameter tag
1232 term
1234 parameter
1236 collision detection
1300 computer system routine
1302 block
1304 block
1306 block
1400 inter-system connection scheduler logic
1402 block
1404 block
1406 block
1408 decision block
1500 connection cadence setting logic
1502 block
1504 block
1506 block
1508 block
1510 block
1600 hot connection logic
1602 block
1604 block
1606 decision block
1608 block
1700 resource forecast module
1702 initializer
1704 controller
1706 algorithm
1708 user interface
1710 code pipeline
1712 resource bins
1714 forecast model
1716 resource data
1718 predicted resource data
1720 event monitor
1722 reporting module
1724 notification system
1726 email
1728 SMS
1730 Web API
1732 set of algorithms
1734 trigger database
1736 forecasting scenario
1802 resource transaction
1804 forecast model
1806 predictor
1808 transaction analyzer
1810 resource position
1812 one or more factors
1814 resource forecast
1816 resource flow stream
1900 resource forecasting system
1902 user interface
1904 resource flow stream, factor, lever database
1906 external resource data
1908 internal resource data
1910 API
1912 market data
1914 resource transactions
1916 resource provider institution
1918 ERP system resource data
1920 user-generated content
1922 resource flow stream editor
1924 one or more levers
2000 resource forecasting system
2002 simulator
2004 company resource forecast
2006 FP&A report
2008 monitor
2010 resource forecast
2012 simulation
2100 method
2102 step
2104 step
2106 step
2108 step
2200 resource forecast
2202 forecast name
2204 start date
2206 end date
2208 update frequency
2210 resource flow stream
2212 levers
2300 resource flow stream
2302 resource flow stream type
2304 factor
2306 tag
2400 factor
2402 event
2404 associated resource flow stream
2406 change
2408 start date
2410 end date
2412 frequency
2500 process
2502 block
2504 block
2506 block
2508 block
2510 block
2512 block
2514 block
2600 client server network configuration
2602 app
2604 network
2606 mobile programmable device
2608 operating system
2610 app
2612 computer
2614 operating system
2616 application
2618 application
2620 server
2622 operating system
2624 service
2626 service
2628 interpreter
2630 driver
2632 driver
2634 driver
2636 driver
2638 file
2640 file
2642 plug-in
2700 machine
2702 instructions
2704 processors
2706 memory
2708 I/O components
2710 bus
2712 processor
2714 processor
2716 main memory
2718 static memory
2720 storage unit
2722 machine-readable medium
2724 output components
2726 input components
2728 biometric components
2730 motion components
2732 environmental components
2734 position components
2736 communication components
2738 network
2740 devices
2742 coupling
2744 coupling

“Algorithm” refers to any set of instructions configured to cause a machine to carry out a particular function or process.

resource data“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Arbitrator” refers to logic that manages contention for a shared computing, communication, or memory resource in a computer system.

“Assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported.

“Cadence rule” refers to a logic setting that controls a rate and/or frequency of connection establishment and data transfers between disparate computer server systems.

“Characteristic” refers to any property, trait, quality, or attribute of an object or thing. Examples of characteristics include, but are not limited to, condition, magnitude, degree, direction, speed, rate of change, readiness for use, unreadiness for use, size, weight, composition, feature set, and the like.

“Circuitry” refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Communication module” refers to any hardware, software, firmware, circuit, electronic component, module, logic, device, or apparatus configured, programmed, designed, arranged, or engineered to manage, direct, and/or control analog or digital communications between two electronic components. A communication module may use a variety of signal transfer media including wired and wireless interconnects (such as Bluetooth, Radio Frequency (RF), or Wi-fi technology (e.g. radio or chip)).

“Company resource forecast” refers to a resource forecast that is representative of all cash related activities for a company.

“Compiled computer code” refers to object code or executable code derived by executing a source code compiler and/or subsequent tools such as a linker or loader.

“Compiler” refers to logic that transforms source code from a high-level programming language into object code or in some cases, into executable code.

“Computer” refers to any computing device. Examples of a computer include, but are not limited to, a personal computer, a laptop, a tablet, a desktop, a server, a main frame, a super computer, a computing node, a virtual computer, a hand held device, a smart phone, a cell phone, a system on a chip, a single chip computer, and the like.

“Computer code” refers to any of source code, object code, or executable code.

“Computer code section” refers to one or more instructions.

“Computer program” refers to another term for ‘application’ or ‘app’.

“Connection cadence” refers to the rate and/or frequency of connection establishment for data transfers between disparate computer server systems.

“Connection scheduler” refers to logic that establishes connections between disparate computer server systems according to a connection cadence determined by cadence rules.

“Controller” refers to a hardware, device, component, element, circuitry, logic, or circuit configured to manage and control operation of another software, hardware, firmware, system, sub-system, device, apparatus, or logic unit, component, device, or component.

“Credit profile” refers to a collection of resource data that represents a borrower, or potential borrowers, history of securing and repaying loans. “Credit profile” may be synonymous with “credit report”.

“Credit report” refers to an organizing data set comprising transaction activity, and resource debt and/or credit levels for an organization.

“Credit score” refers to a numerical value or range of numerical values that provide a metric of a borrower's ability to repay a loan of resources.

“Credit worthiness data” refers to resource data that may be used by a resource provider institution to determine whether to extend financial credit, in the form of a loan or line of credit to a borrower, and/or what amount of money to set for the loan or maximum for the line of credit.

“Daemon” refers to logic that executes without a user interface and which performs a background function in a computer system.

“De-coupling boundary” refers to an interface between two communicating logic components that decouples the rate at which one component transforms its inputs to outputs from the rate at which the other component transforms its inputs to outputs.

“Direct method” refers to one of two techniques used to generate a resource flow statement. The “direct method” uses actual inflows and outflows from the company's operations. Accrual accounting recognizes revenue or other resources when earned versus when the received from a customer. Conversely, the direct method measures only the resources received and the outflows. The inflows and outflows are netted to arrive at the resource flow.

“Disparate computer server systems” refers to physically distinct and separate computer systems operated by distinct and separate companies and accessible over distinct and separate communication channels from one another.

“Driver” refers to low-level logic, typically software, that controls components of a device. Drivers often control the interface between an operating system or application and input/output components or peripherals of a device, for example.

“Engine” refers to logic that transforms inputs into outputs with adjustable performance. Engine logic may “idle” if no inputs are available for transformation.

“ERP” is an acronym for “enterprise resource planning”.

“ERP system” refers to one or more systems comprising hardware, software, interfaces, databases, either alone or in combination, that collect, track, and report on business process information for a company. In general, ERP systems provide access to data that support the business processes in real-time, or near real time. ERP systems and the data they manage may support a variety of business functions or departments, including but not limited to, manufacturing, purchasing, sales, accounting, human resources, supply chain management, project management, customer relationship management, and the like. ERP systems that support accounting manage resource data relating to the general ledger, fixed assets, accounts payable, accounts receivable, resource management, and the like. Examples of ERP systems, ERP system vendors, and/or components that are part of an ERP system, include, but are not limited to, Netsuite®, Salesforce.com®, Workday, SAP, Oracle, Microsoft Dynamics, and the like.

“ERP system resource data” refers to resource data supplied by an ERP system representing resource levels, inflows, and outflows. Examples include open accounts receivable (A/R) and accounts payable (A/P) invoices; open purchase orders (POs) with both vendors and customers; payments made by payment type and related details such as payment date; vendor payment terms (payables) and/or customer collections terms (receivables); chart of accounts, including account codes by vendor and/or customer for expense and revenue recognition, respectively, and the like; and transactions posted to a ledger that can be used to aid in reconciliation.

“Executable” refers to a file comprising executable code. If the executable code is not interpreted computer code, a loader is typically used to load the executable for execution by a programmable device.

“Executable code” refers to Instructions in a ready-to-execute form by a programmable device. For example, source code instructions in non-interpreted execution environments are not executable code because they must usually first undergo compilation, linking, and loading by the operating system before they have the proper form for execution. Interpreted computer code may be considered executable code because it can be directly applied to a programmable device (an interpreter) for execution, even though the interpreter itself may further transform the interpreted computer code into machine language instructions.

“Factor” refers to a machine configuration setting applied to influence the content of a resource flow stream.

“File” refers to a unitary package for storing, retrieving, and communicating data and/or instructions. A file is distinguished from other types of packaging by having associated management metadata utilized by the operating system to identify, characterize, and access the file.

“Firmware” refers to software logic embodied as processor-executable instructions stored on volatile memory media and/or non-volatile memory media.

“Forecast model” refers to a set of parameters, data values, assumptions, and events, or potential events, that a user wants to use as a basis for generating a resource forecast.

“Future resource flow” refers to a resource flow for a distinct point in time or a period of time in the future.

“Hardware” refers to logic embodied as analog and/or digital circuitry.

“Historical resource transaction” refers to a resource transaction that occurs in the past.

“Hot connection module” refers to logic that maintains a communication session open across configured timeout conditions.

“Indexing module” refers to logic that transforms received data signals into a searchable index.

“Ingest module” refers to logic that opens and operates communication sessions to pull data from disparate computer server systems.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Interpreted computer code” refers to Instructions in a form suitable for execution by an interpreter.

“Interpreter” refers to an interpreter is logic that directly executes instructions written in a source code scripting language, without requiring the instructions to a priori be compiled into machine language. An interpreter translates the instructions into another form, for example into machine language, or into calls to internal functions and/or calls to functions in other software modules.

“Lever” refers to a characteristic or attribute relating to a resource forecast. A lever is similar to a factor, except that a lever affects an entire forecast (e.g., all streams and factors) at a macro level.

“Library” refers to a collection of modules organized such that the functionality of all the modules may be included for use by software using references to the library in source code.

“Linker” refers to Logic that inputs one or more object code files generated by a compiler or an assembler and combines them into a single executable, library, or other unified object code output. One implementation of a linker directs its output directly to machine memory as executable code (performing the function of a loader as well).

“Loader” refers to Logic for loading programs and libraries. The loader is typically implemented by the operating system. A typical loader copies an executable into memory and prepares it for execution by performing certain transformations, such as on memory addresses.

“Logic” refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Machine language” refers to Instructions in a form that is directly executable by a programmable device without further translation by a compiler, interpreter, or assembler. In digital devices, machine language instructions are typically sequences of ones and zeros.

“Memory” refers to any hardware, circuit, component, module, logic, device, or apparatus configured, programmed, designed, arranged, or engineered to retain data. Certain types of memory require availability of a constant power source to store and retain the data. Other types of memory retain and/or store the data when a power source is unavailable.

“Metadata control setting” refers to settings that control the establishment of secure connections between disparate computer server systems.

“Metadata control settings” refers to settings that control the establishment of secure connections between disparate computer server systems.

“Module” refers to a computer code section having defined entry and exit points. Examples of modules are any software comprising an application program interface, drivers, libraries, functions, and subroutines.

“Neural network” refers to any logic, circuitry, component, chip, die, package, module, system, sub-system, or computing system configured to perform tasks by imitating biological neural networks of people or animals. Neural network, as used herein, may also be referred to as artificial neural network (ANN). Examples of neural networks that may be used with various embodiments of the disclosed solution include, but are not limited to, convolutional neural networks, feed forward neural networks, radial basis neural network, recurrent neural networks, modular neural networks, and the like.

A neural network may include both the logic, software, firmware, and/or circuitry for implementing the neural network as well as the data and metadata for operating the neural network. One or more of these components for a neural network may be embodied in one or more of a variety of repositories, including in one or more files, databases, folders, or the like.

The neural network used with embodiments disclosed herein may employ one or more of a variety of learning models including, but not limited to, supervised learning, unsupervised learning, and reinforcement learning. These learning models may employ various backpropagation techniques.

“Non-volatile memory” refers to shorthand name for non-volatile memory media. In certain embodiments, non-volatile memory media refers to the non-volatile memory media and the logic, controllers, processor(s), state machine(s), and/or other periphery circuits that manage the non-volatile memory media and provide access to the non-volatile memory media.

“Non-volatile memory media” refers to any hardware, device, component, element, or circuit configured to maintain an alterable physical characteristic used to represent a binary value of zero or one after a primary power source is removed.

“Normalizing module” refers to logic that transforms data received from disparate computer server systems in various and different formats into a common format.

“Object code” refers to the computer code output by a compiler or as an intermediate output of an interpreter. Object code often takes the form of machine language or an intermediate language such as register transfer language (RTL).

“On-demand company resource forecasts” refers to a resource forecast that is generated in response to a user request.

“Operating system” refers to Logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Outflow engine” refers to engine logic utilized by the outflow module.

“Outflow module” refers to logic that services on-demand or scheduled requests for structured data for utilization by client apps and applications to generate structured user interfaces and graphical visualizations.

“Percentage change factor” refers to a factor configured to change the resource flow for a resource stream by a predetermined percentage over time with a predefined frequency. For example, In one embodiment, the percentage change factor comprises a percentage increase, for example, 0.025%, with a frequency interval, such as each pay period. For example, In one embodiment, the percentage change factor comprises a percentage decrease, for example, 0.025%, with frequency interval, such as each future pay period.

“Plug-in” refers to software that adds features to an existing computer program without rebuilding (e.g., changing or re-compiling) the computer program. Plug-ins are commonly used for example with Internet browser applications.

“Process” refers to software that is in the process of being executed on a device.

“Processor” refers to any circuitry, component, chip, die, package, or module configured to receive, interpret, decode, and execute machine instructions. Examples of a processor may include, but are not limited to, a central processing unit, a general-purpose processor, an application-specific processor, a graphics processing unit (GPU), a field programmable gate array (FPGA), application Specific Integrated Circuit (ASIC), System on a Chip (SoC), virtual processor, processor core, and the like.

“Programmable device” refers to any logic (including hardware and software logic) who's operational behavior is configurable with instructions.

“Pushing” refers to implementing a data transfer over a link or across a boundary independently of receiving a request or trigger for the data transfer from the target of the data transfer.

“Relationship” refers to a magnitude and rate of change in either a positive or negative direction for a resource position of a resource flow stream. In one embodiment, the relationship is based at least in part on historical resource transactions. In another embodiment, the relationship is based at least in part on historical resource transactions for a particular resource flow stream.

“Resource account” refers to an account with an institution for maintaining and tracking resource levels.

“Resource bin” refers to a storage location that holds resources and/or records of resource transactions.

“Resource co-operative” refers to an association of persons or legal entities united to meet their common resource needs.

“Resource credit exchange” refers to a common site, location, platform, system, and/or tool, configured to complete a resource transaction relating to the offering and/or securing of credit between two parties.

“Resource data” refers to any data relating to or representative of a resource transaction that occurred in the past, in a present resource transaction, or at a future resource transaction.

“Resource exchange” refers to a common site, location, platform, system, and/or tool, configured to complete a resource transaction relating to the receiving or providing of resources to at least one party.

“Resource flow” refers to the inflows and outflows that a company, or part of a company, undertakes during a given time period. A “company” is any organization as that term is commonly understood.

“Resource flow log” refers to a resource transaction statement that provides aggregate data regarding all resource inflows a company, or part of a company, receives from its ongoing operations and external investment sources. It also includes all resource outflows that pay for business activities and investments during a given period.

“Resource flow statement” refers to a resource transaction statement that provides aggregate data regarding all cash inflows a company, or part of a company, receives from its ongoing operations and external investment sources. It also includes all cash outflows that pay for business activities and investments during a given period.

“Resource flow stream” refers to a projected resource flow for a specific part of a company. In one embodiment, at a broad level, the resource flow represents resource flow for all operations of a company.

A resource flow stream is a projection of resource data representing resource flows, in or out, relating to a particular type of business transaction, such as income or expenses. The claimed solutions may generate streams in a number of ways, including, without limitation, auto-generated with tags, user-defined scripts that a serverless cloud computing platform may execute, or manually with user-generated content using entered data or user uploaded files, such as a spreadsheet.

A resource flow is a grouping of resource transactions and other business activity that affects a company's resource position, whereas a stream is a subset of that grouping of resource transactions and other business activity that affects a company's resource position.

Examples of resource flow streams include, but are not limited to, energy consumption streams, bandwidth utilization streams, data storage streams, revenue streams, general expenses streams, accounts payable streams, accounts receivable streams, inventory streams, capital expenditures streams, payroll streams, and financing streams.

“Resource forecast” refers to a projection of a resource position of a company at a specific future time, or over a specific future period of time.

“Resource forecast module” refers to any hardware, circuit, component, module, logic, device, or apparatus configured, programmed, designed, arranged, or engineered to determine a resource forecast.

“Resource forecaster” refers to any hardware, circuit, component, module, logic, device, or apparatus configured, programmed, designed, arranged, or engineered to determine a resource forecast and/or a resource position at a point in time in the future.

“Resource pool” refers to a collection of resources stored for ease of input from and output to a plurality of organizations.

“Resource pool loan request” refers to a request from a company to a resource pool to obtain a resource loan. A resource pool loan request may include terms for the loan. In certain embodiments, the terms may be predefined and may be set at default amounts for the amount or range, time of the loan, interest rate, and repayment terms.

“Resource pooling system” refers to a system configured to manage deposits of resources from participating members of a resource exchange and to manage issuance of credits for resources from a resource pool.

“Resource position” refers to the amount of resources held by a company or on behalf of the company by an associated resource provider institution at any specific point in time.

“Resource provider institution” refers to a company engaged in the business of providing resources (e.g., via sales and/or loans).

“Resource sources stream” refers to a stream configured to represent exclusively transactions that result in a credit to a resource account of the company.

“Resource transaction statement” refers to records of the transaction activities and position of a company. A resource flow statement is one example of such a transaction statement that records a company's resource flow behavior.

“Resource uses stream” refers to a stream configured to represent exclusively resource transactions that result in a debit to an account of the company.

“Sequential disclosure level” refers to an organization of resource data such at each level in a sequence of levels of the resource data discloses more details and/or a longer history of information relating to the resource data.

“Serverless” refers to a computing system architected such that performance scalability is enabled by configuring, either automatically or via manually configured control settings, units of resource consumption (e.g., computational units, communication bandwidth, memory) rather than by adding or removing entire computer servers.

“Serverless cloud computing platform” refers to a set of processing hardware (processors), memory hardware (non-volatile memory and/or volatile memory), storage hardware (storage devices), networking hardware, software, firmware, systems, subsystems, components, circuits, and logic configured to implement a cloud computing serverless execution model. Examples of components, systems, architectures, functionality, and logic that may be included in a serverless cloud computing platform include AWS Lambda, AWS Dynamo, AWS RDS, AWS S3, AWS Elastic Search, Amazon SNS, and/or Amazon Gateway.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Simulation” refers to the representation of the behavior or characteristics of one system through the use of another system, especially a computer program designed for the purpose.

“Software” refers to Logic implemented as instructions for controlling a programmable device or component of a device (e.g., a programmable processor, controller). software can be source code, object code, executable code, machine language code. Unless otherwise indicated by context, software shall be understood to mean the embodiment of said code in a machine memory or hardware component, including “firmware” and micro-code.

“Source code” refers to a high-level textual computer language that requires either interpretation or compilation in order to be executed by a device.

“Storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like.

“Subroutine” refers to a module configured to perform one or more calculations or other processes. In some contexts the term ‘subroutine’ refers to a module that does not return a value to the logic that invokes it, whereas a ‘function’ returns a value. However herein the term ‘subroutine’ is used synonymously with ‘function’.

“Tag” refers to a label associated with a filter condition. An example of a filter condition is a Structured Query Language or Boolean logic setting. An example of a tag (the format is just an example) is: September Large Transactions->“amount>$100 AND 9/1/2019<=date<=9/30/2019”

“Task” refers to one or more operations that a process performs.

“Time shift factor” refers to a factor configured to change the resource flow for a resource flow stream by a calculated amount based on a timing policy for a resource transaction shifting earlier in time or later in time.

For example, In one embodiment, the time shift factor is defined such that all invoices payable by the company are shifted “x” number of days forward in time, accelerating the payments beyond a payment policy and the associated resource flow stream is adjusted by the amount that this factor changes the resource flow. For example, in another embodiment, the time shift factor is defined such that all invoices payable by the company are shifted “x” number of days backward in time, delaying the payments beyond a payment policy and the associated resource flow stream is adjusted by the amount that this factor changes the resource flow.

“Total resource balance” refers to refers to a total amount of a particular resource aggregated across each company account for that type of resource.

“Trigger” refers to any condition, criteria, or pre-requisite associated with a suitable event and/or set of circumstances for relates to the change in resource position for an operating company. An example trigger includes, but is not limited to, a passage of time, receipt of a threshold number of orders, a change in stock price, a change in account balance, among other events and/or circumstances that are possible and contemplated herein.

“Updated credit worthiness data” refers to revised credit worthiness data from credit worthiness data determined earlier in time. Various factors may result in an updated credit worthiness data, each of these factors may trigger the resource management system, and/or a component of the system, to determine an updated credit worthiness data. Examples of factors that may result in, or trigger, generation of updated credit worthiness data may include, but is not limited to: passage of time since a loan was extended to a company, a change in management at the company, a change in stock price for the company by a threshold amount, an amount borrowed on a line of credit loan crossing a threshold, an amount or degree to which a company's future resource position aligns with one or more resource forecasts, an amount of a loan that is outstanding and unpaid and/or overdue for payment, and the like.

“User” refers to a human operator of a system.

“User interface” refers to a set of logic, components, devices, software, firmware, and peripherals configured to facilitate interactions between humans and machines and/or computing devices.

“User override” refers to a control setting by a user that preempts or replaces a system setting.

“User-generated content” refers to any resource data supplied by a user for use in managing resource flow(s) and resource flow analysis.

“Volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media.

“Volatile memory media” refers to any hardware, device, component, element, or circuit configured to maintain an alterable physical characteristic used to represent a binary value of zero or one for which the alterable physical characteristic reverts to a default state that no longer represents the binary value when a primary power source is removed or unless a primary power source is used to refresh the represented binary value. Examples of volatile memory media include but are not limited to dynamic random-access memory (DRAM), static random-access memory (SRAM), double data rate random-access memory (DDR RAM) or other random access solid state memory While the volatile memory media is referred to herein as “memory media,” in various embodiments, the volatile memory media may more generally be referred to as volatile memory. In certain embodiments, data stored in volatile memory media is addressable at a byte level which means that the data in the volatile memory media is organized in to bytes (8 bits) of data that each have a unique address, such as a logical address.

“Web application” refers to an application or app that is stored on a remote server and delivered over the Internet through a browser interface.

“Web integration service” refers to a container for a web service, providing an API between the web service and external logic.

“Web service” refers to a service that listens for requests (typically at a particular network port) and provides functionality (e.g., Javascript, algorithms, procedures) and/or data (e.g., HTML, JSON, XML) in response to the requests.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method of operating a resource credit exchange for a resource of a particular type, the method comprising:
for a member company:
operating an ingest module on a first side of a de-coupling boundary on outputs of a hot connection module to resource accounts of the member company;
processing outputs of the ingest module with an indexing module asynchronously from the ingest module on a second side of the de-coupling boundary to generate a search index;
generating a resource model input by applying onto transaction records referenced in the search index a hierarchical transaction grouping control structure comprising one or more inheritance tag relationships and one or more container tag relationships;
operating a resource forecaster on the resource model input to generate a resource position and a resource flow; and
applying the resource position and the resource flow to the resource credit exchange coupled to a plurality of resource provider institutions;
operating the resource credit exchange to:
generate a digital contract based on the resource position and resource flow; and
initiate an outflow of resource deposits from a subset of the resource provider institutions to the member company under terms of the digital contract.

2. The method of claim 1, further comprising:
determining a credit profile for the member company; and
configuring terms of the digital contract on a blockchain based on the credit profile.

3. The method of claim 1, the method further comprising:
at each of a configured time interval:
operating the resource forecaster on the resource model input to generate an updated resource position and an updated resource flow; and
modifying the terms of the digital contract on a blockchain, based on the updated resource position and the updated resource flow.

4. The method of claim 1, further comprising:
the resource provider institutions coupled to a resource pool; and
triggering one or more of the resource provider institutions to loan the outflow of resources to the resource pool in response to a level of the resource pool falling below a configured threshold.

5. The method of claim 1, further comprising:
configuring triggers for initiating the outflow of resource deposits.

6. The method of claim 1, the hot connection module responsive to a plurality of metadata control settings for disparate computer server systems, the control settings implementing cadence rules for connection to and data transfer from the disparate computer server systems.

7. The method of claim 6, further comprising:
the hot connection module configured to execute a connection cadence on each of the disparate computer server systems based on the cadence rules.

8. The method of claim 6, further comprising:
operating a serverless cloud computing platform to determine the resource position based on at least resource transactions and ERP system resource data for the member company; and
operating the serverless cloud computing platform to generate a resource forecast based on the resource position and one or more resource flow streams of the resource flow for the member company, each resource flow stream comprising one or more factors.

9. The method of claim 8, wherein each factor comprises a percentage change factor configured to change a resource flow stream resource position by a percentage with a frequency.

10. The method of claim 8, wherein the factor comprises a time shift factor configured to change a resource flow stream resource position by an amount based on changing a time that a resource transaction is to be completed.

11. A serverless cloud computing platform implementing a resource credit exchange for a resource of a particular type, the computing platform comprising:
an ingest module operative on a first side of a de-coupling boundary on outputs of a hot connection module to resource accounts of the member company;
an indexing module operative to process outputs of the ingest module asynchronously from the ingest module on a second side of the de-coupling boundary to generate a search index;
logic configured to generate a resource model input by applying onto transaction records referenced in the search index a hierarchical transaction grouping control structure comprising one or more inheritance tag relationships and one or more container tag relationships;
a resource forecaster configured to transform the resource model input into a resource position and a resource flow;
the resource credit exchange coupled to receive the resource position and the resource flow and further coupled to a plurality of resource provider institutions;
the resource credit exchange comprising logic configured to:
generate a digital contract based on the resource position and resource flow; and
initiate an outflow of resource deposits from a subset of the resource provider institutions to the member company under terms of the digital contract.

12. The computing platform of claim 11, further comprising:
logic operative to form a credit profile for the member company; and
configuring terms of the digital contract on a blockchain based on the credit profile.

13. The computing platform of claim 11, further comprising:
the resource forecaster configured to operate on the resource model input on a configured time interval to generate an updated resource position and an updated resource flow; and
logic configured to modify the terms of the digital contract on a blockchain, based on the updated resource position and the updated resource flow.

14. The computing platform of claim 11, further comprising:
a resource pool coupled to the resource provider institutions; and
logic to trigger one or more of the resource provider institutions to loan the outflow of resources to the resource pool in response to a level of the resource pool falling below a configured threshold.

15. The computing platform of claim 11, further comprising:
configured triggers for initiating the outflow of resource deposits.

16. The computing platform of claim 11, the hot connection module configured to respond to a plurality of metadata control settings for disparate computer server systems, the control settings implementing cadence rules for connection to and data transfer from the disparate computer server systems.

17. The computing platform of claim 16, further comprising:
the hot connection module configured to execute a connection cadence on each of the disparate computer server systems based on the cadence rules.

18. The computing platform of claim 16, further comprising:
a serverless cloud computing platform configured to determine the resource position based on at least resource transactions and ERP system resource data for the member company; and
the serverless cloud computing platform configured to generate a resource forecast based on the resource position and one or more resource flow streams of the resource flow for the member company, each resource flow stream comprising one or more factors.

19. The computing platform of claim 18, wherein each factor comprises a percentage change factor configured to change a resource flow stream resource position by a percentage with a frequency.

20. The computing platform of claim 18, wherein the factor comprises a time shift factor configured to change a resource flow stream resource position by an amount based on changing a time that a resource transaction is to be completed.
